(19) United States
(12) Patent Application Publication
(10) Pub. No.: US 2010/0260484 A1
(43) Pub. Date: Oct. 14, 2010

(54) PLAYBACK APPARATUS, PLAYBACK METHOD, AND PROGRAM

(75) Inventor: Shinobu HATTORI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/721,679

(22) Filed: Mar. 11, 2010

(30) Foreign Application Priority Data
Apr. 8, 2009 (JP) 2009-094259

(51) Int. Cl. H04N 5/91; H04N 7/26

(52) U.S. Cl. 386/108; 386/109; 386/E05.003

(57) ABSTRACT

A playback apparatus includes a first deciding unit configured to decode the stream of a Base view video and the stream of a Dependent view video, a second decoding unit configured to decode the graphic stream of a Base view and the graphic stream of a Dependent view, and a synthesizing unit configured to generate a first synthesizing plane by synthesizing a plane of the Base view video obtained based on the decoding result and a plane of Base view graphics obtained based on the decoding result and to generate a second synthesizing plane by synthesizing a plane of the Dependent view video obtained based on the decoding result and a plane of Dependent view graphics obtained based on the decoding result.

### BACKGROUND OF THE INVENTION

1. Field of the Invention

The present invention relates to a playback apparatus, a playback method, and a program, and particularly to a playback apparatus, a playback method and a program that enables the playback of 3D content that is recorded in a recording medium such as BD or the like and formed of streams of a Base view video and streams of a Dependent view video obtained by encoding with the H.264 AVC/MVC appropriately with graphic streams.

2. Description of the Related Art

There has been mostly two-dimensional image content as content of movies or the like, but in recent years, content of stereoscopic images that enables a stereoscopic view has gained attention.

A dedicated device is necessary for the display of the stereoscopic images, and as such a device for stereoscopic viewing, for example, there is an Integral Photography Three-dimensional Image System developed by Japan Broadcasting Corporation (NHK).

Image data of stereoscopic images are formed with image data of a plurality of viewpoints (image data of images captured from a plurality of viewpoints), and as the number of viewpoints increase and the range of the viewpoints widen, it is possible to realize a so-called “looking-in television” on which an object can be seen from various directions.

Among stereoscopic images, images with the minimum number of viewpoints are stereo images with two viewpoints (so-called 3D images). Image data of stereo images includes data of left images which are observed by the left eye and data of right images which are observed by the right eye.

On the other hand, since image content with high resolution such as movies or the like has a large amount of the data, a recording medium with a large capacity is necessary for recording such content with a large amount of data.

As such a recording medium with a large capacity, there are Blu-Ray (registered trademark) disc (hereinafter, referred to as “BD”) such as Blu-Ray (BR) (registered trademark)-Read Only Memory (ROM)), or the like.

### SUMMARY OF THE INVENTION

However, the BD standard does not define how image data of stereoscopic images including stereo images can be recorded on the BD or played back.

Image data of stereo images includes two data streams, a data stream of left images and a data stream of right images. In addition, when subtitles of a movie or buttons that a user operates are to be subjected to stereo display, graphic streams for the display are prepared with two streams which are for the left eye and the right eye.

For this reason, it is necessary that a decoder model that can play back an image data stream and a graphic stream together, and display stereo images is defined and a decoder corresponding to the model is mounted on a playback apparatus.

The present invention took into consideration such matters and it is desirable to play back 3D content that is recorded on a recording medium such as BD or the like and includes a stream of a Base view video and a stream of a Dependent view video obtained by encoding with the H.264 AVC/MVC appropriately with a graphic stream.

According to a first embodiment of the present invention, there is provided a playback apparatus including a first decoding unit configured to decode the stream of a Base view video and the stream of a Dependent view video obtained by encoding a plurality of pieces of video data with predetermined video format, a second decoding unit configured to decode the graphic stream of a Base view and the graphic stream of a Dependent view, and a synthesizing unit configured to generate a first synthesizing plane by synthesizing a plane of the Base view video obtained based on the decoding result of the stream of the Base view video and a plane of Base view graphics obtained based on the decoding result of the graphic stream of the Base view, and to generate a second synthesizing plane by synthesizing a plane of the Dependent view video obtained based on the decoding result of the stream of the Dependent view video and a plane of Dependent view graphics obtained based on the decoding result of the graphic stream of the Dependent view.

According to the above embodiment of the present invention, the playback apparatus further includes a switching unit configured to output one synthesizing plane among the first synthesizing plane and the second synthesizing plane as a plane of a left image and to output the other synthesizing plane as a plane of a right image based on a flag indicating whether one of stream between the stream of the Base view video and the stream of the Dependent view video is a stream of the left image or a stream of the right image.

According to the above embodiment of the present invention, the switching unit identifies whether the first synthesizing plane is a plane obtained by synthesizing planes of the Base view and whether the second synthesizing plane is a plane obtained by synthesizing planes of the Dependent view, based on a PID.

According to the above embodiment of the present invention, the switching unit identifies whether the first synthesizing plane is a plane obtained by synthesizing planes of the Base view and whether the second synthesizing plane is a plane obtained by synthesizing planes of the Dependent view, based on a view ID set to the stream of the Dependent view video during encoding.

According to a second embodiment of the present invention, there is provided a playback method including the steps of decoding the stream of a Base view video and the stream of a Dependent view video obtained by encoding a plurality of pieces of video data with predetermined video format, decoding the graphic stream of a Base view and the graphic stream of a Dependent view, and generating a first synthesizing plane by synthesizing a plane of the Base view video obtained based on the decoding result of the stream of the Base view video and a plane of Base view graphics obtained based on the decoding result of the graphic stream of the Base view, and generating a second synthesizing plane by synthesizing a plane of the Dependent view video obtained based on the decoding result of the stream of the Dependent view video and a plane of Dependent view graphics obtained based on the decoding result of the graphic stream of the Dependent view.

According to a third embodiment of the present invention, there is provided a program prompting a computer to execute a process including the steps of decoding the stream of a Base view video and the stream of a Dependent view video obtained by encoding a plurality of pieces of video data with predetermined video format, decoding the graphic stream of a Base view and the graphic stream of a Dependent view, and generating a first synthesizing plane by synthesizing a plane of the Base view video obtained based on the decoding result of the stream of the Base view video and a plane of Base view graphics obtained based on the decoding result of the graphic stream of the Base view, and generating a second synthesizing plane by synthesizing a plane of the Dependent view video obtained based on the decoding result of the stream of the Dependent view video and a plane of Dependent view graphics obtained based on the decoding result of the graphic stream of the Dependent view.

According to a fourth embodiment of the present invention, there is provided a playback apparatus including a first decoding unit configured to decode the stream of a Base view video and the stream of a Dependent view video obtained by encoding a plurality of pieces of video data with predetermined video format, a first switching unit configured to output one plane out of a plane of the Base view video obtained based on the decoding result of the stream of the Base view video and a plane of the Dependent view video obtained based on the decoding result of the stream of the Dependent view video as a plane of a first left image and to output the other plane as a first right image based on a flag indicating whether one of stream between the stream of the Base view video and the stream of the Dependent view video is a stream of the left image or a stream of the right image, a second decoding unit configured to decode the graphic stream of a Base view and the graphic stream of a Dependent view, a second switching unit configured to output one plane out of a plane of Base view graphics obtained based on the decoding result of the graphic stream of the Base view and a plane of Dependent view graphics obtained based on the decoding result of the graphic stream of the Dependent view as a plane of a second left image and to output the other plane as a plane of a second right image based on the flag, and a synthesizing unit configured to generate a first synthesizing plane by synthesizing the plane of the first left image and the plane of the second left image, and to generate a second synthesizing plane by synthesizing the plane of the first right image and the plane of the second right image.

According to a fifth embodiment of the present invention, there is provided a playback method including the steps of decoding the stream of a Base view video and the stream of a Dependent view video obtained by encoding a plurality of pieces of video data with predetermined video format, outputting one plane out of a plane of the Base view video obtained based on the decoding result of the stream of the Base view video and a plane of the Dependent view video obtained based on the decoding result of the stream of the Dependent view video as a plane of a first left image and outputting the other plane as a first right image based on a flag indicating whether one of stream between the stream of the Base view video and the stream of the Dependent view video is a stream of the left image or a stream of the right image, decoding the graphic stream of a Base view and the graphic stream of a Dependent view, outputting one plane out of a plane of Base view graphics obtained based on the decoding result of the graphic stream of the Base view and a plane of Dependent view graphics obtained based on the decoding result of the graphic stream of the Dependent view as a plane of a second left image and outputting the other plane as a plane of a second right image based on the flag, and generating a first synthesizing plane by synthesizing the plane of the first left image and the plane of the second left image, and generating a second synthesizing plane by synthesizing the plane of the first right image and the plane of the second right image.

According to a sixth embodiment of the present invention, there is provided a program prompting a computer to execute a process including the steps of decoding the stream of a Base view video and the stream of a Dependent view video obtained by encoding a plurality of pieces of video data with predetermined video format, outputting one plane out of a plane of the Base view video obtained based on the decoding result of the stream of the Base view video and a plane of the Dependent view video obtained based on the decoding result of the stream of the Dependent view video as a plane of a first left image and outputting the other plane as a first right image based on a flag indicating whether one of stream between the stream of the Base view video and the stream of the Dependent view video is a stream of the left image or a stream of the right image, decoding the graphic stream of a Base view and the graphic stream of a Dependent view, outputting one plane out of a plane of Base view graphics obtained based on the decoding result of the graphic stream of the Base view and a plane of Dependent view graphics obtained based on the decoding result of the graphic stream of the Dependent view as a plane of a second left image and outputting the other plane as a plane of a second right image based on the flag, generating a first synthesizing plane by synthesizing the plane of the first left image and the plane of the second left image, and generating a second synthesizing plane by synthesizing the plane of the first right image and the plane of the second right image.

According to an embodiment of the present invention, a stream of a Base view video and a stream of a Dependent view video obtained by encoding a plurality of video data are decoded with predetermined video format, a graphic stream of a Base view and a graphic stream of a Dependent view are decoded, a first synthesizing plane is generated by synthesizing a plane of the Base view video obtained based on the decoding result of the stream of the Base view video and a plane of a Base view graphics obtained based on the decoding result of the graphic stream of the Base view, and a second synthesizing plane is generated by synthesizing a plane of the Dependent view video obtained based on the decoding result of the stream of the Dependent view video and a plane of a Dependent view graphics obtained based on the decoding result of the graphic stream of the Dependent view.

According to an embodiment of the present invention, the stream of a Base view video and the stream of a Dependent view video obtained by encoding a plurality of pieces of video data are decoded with predetermined video format, one plane out of a plane of the Base view video obtained based on the decoding result of the stream of the Base view video and a plane of the Dependent view video obtained based on the decoding result of the stream of the Dependent view video is output as a plane of a first left image and the other plane is output as a first right image based on a flag indicating whether one of stream between the stream of the Base view video and the stream of the Dependent view video is a stream of the left image or a stream of the right image. In addition, the graphic stream of a Base view and the graphic stream of a Dependent view are decoded, one plane out of a plane of Base view graphics obtained based on the decoding result of the graphic stream of the Base view and a plane of Dependent view graphics obtained based on the decoding result of the graphic stream of the Dependent view is output as a plane of a second left image and the other plane is output as a plane of a second right image based on the flag, a first synthesizing plane is generated by synthesizing the plane of the first left image and the plane of the second left image, and a second synthesizing plane is generated by synthesizing the plane of the first right image and the plane of the second right image.

According to the present invention, 3D content, that is recorded on a recording medium such as BD or the like and includes a stream of a Base view video and a stream of a Dependent view video obtained by encoding with the H.264 AVC/MVC, is played back appropriately with a graphic stream.

### BRIEF DESCRIPTION OF THE DRAWINGS

FIG. 1 is a diagram illustrating an example of a composition of a playback system including a playback apparatus to which the present invention is applied;

FIG. 2 is a diagram illustrating an example of image-capturing;

FIG. 3 is a block diagram illustrating an example of a composition of an MVC encoder;

FIG. 4 is a diagram illustrating an example of a reference image;

FIG. 5 is a diagram illustrating an example of a composition of TS;

FIG. 6 is a diagram illustrating an example of another composition of TS;

FIGS. 7A and 7B are diagrams illustrating examples of still another composition of TS;

FIG. 8 is a diagram illustrating an example of the management of AV stream;

FIG. 9 is a diagram illustrating the structure of Main Path and Sub Path;

FIG. 10 is a diagram illustrating an example of the management structure for files recorded on an optical disc;

FIG. 11 is a diagram illustrating the syntax of a PlayList file;

FIG. 12 is a diagram illustrating an example of using a method of reserved_for_future_use shown in FIG. 11;

FIG. 13 is a diagram illustrating the meaning of values of 3D_PL_type;

FIG. 14 is a diagram illustrating the meaning of values of view_type;

FIG. 15 is a diagram illustrating the syntax of the PlayList( ) in FIG. 11;

FIG. 16 is a diagram illustrating the syntax of the SubPath( ) in FIG. 15;

FIG. 17 is a diagram illustrating the syntax of the SubPlayItem(i) in FIG. 16;

FIG. 18 is a diagram illustrating the syntax of the PlayItem( ) in FIG. 15;

FIG. 19 is a diagram illustrating the syntax of the STN_table( ) in FIG. 18;

FIG. 20 is a block diagram illustrating an example of the composition of a playback apparatus;

FIG. 21 is a diagram illustrating an example of the composition of a decoder unit in FIG. 20;

FIG. 22 is a diagram illustrating a composition for performing a process of a video stream;

FIG. 23 is a diagram illustrating the composition for performing the process of the video stream;

FIG. 24 is a diagram illustrating another composition for performing a process of a video stream;

FIG. 25 is a diagram illustrating an example of Access Unit;

FIG. 26 is a diagram illustrating still another composition for performing a process of a video stream;

FIG. 27 is a diagram illustrating the composition of a synthesizing unit and the previous stage;

FIG. 28 is another diagram illustrating the composition of a synthesizing unit and the previous stage;

FIG. 29 is a block diagram illustrating an example of the composition of a software production processing unit;

FIG. 30 is a diagram illustrating an example of each composition including the software production processing unit;

FIG. 31 is a diagram illustrating an example of a composition of a 3D video TS generating unit provided in a recording device;

FIG. 32 is a diagram illustrating an example of another composition of a 3D video TS generating unit provided in a recording device;

FIG. 33 is a diagram illustrating an example of still another composition of a 3D video TS generating unit provided in a recording device;

FIG. 34 is a diagram illustrating the composition of a playback apparatus decoding Access Unit;

FIG. 35 is a diagram illustrating a decoding process;

FIG. 36 is a diagram illustrating the structure of a Closed GOP;

FIG. 37 is a diagram illustrating the structure of an Open GOP;

FIG. 38 is a diagram illustrating the maximum number of frames and fields in GOP;

FIG. 39 is a diagram illustrating the structure of a Closed GOP;

FIG. 40 is a diagram illustrating the structure of an Open GOP;

FIG. 41 is a diagram illustrating an example of a decoding starting point set in EP_map;

FIG. 42 is a diagram illustrating a problem occurring when the structure of a GOP of Dependent view video is not defined;

FIG. 43 is a diagram illustrating the concept of picture search;

FIG. 44 is a diagram illustrating the structure of an AV stream recorded on an optical disc;

FIG. 45 is a diagram illustrating an example of a Clip AV stream;

FIG. 46 is a diagram conceptually illustrating an EP_map corresponding to the Clip AV stream of FIG. 45;

FIG. 47 is a diagram illustrating an example of the data structure of source packets that SPN_EP_start indicates; and

FIG. 48 is a block diagram illustrating an example of the composition of hardware in a computer.

### DESCRIPTION OF THE PREFERRED EMBODIMENTS

### First Embodiment

### Example of Composition of Playback System

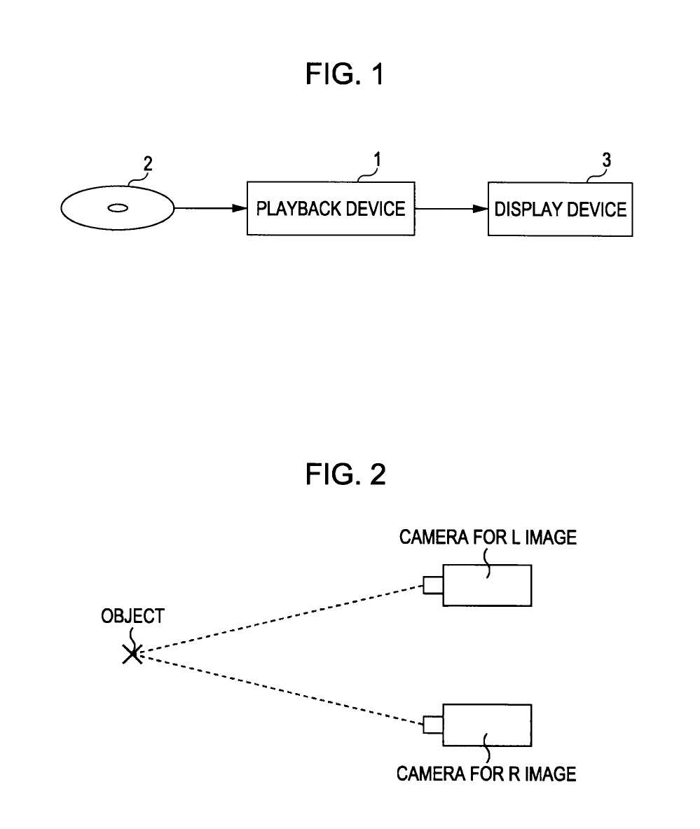

FIG. 1 is a diagram illustrating an example of a composition of a playback system including a playback apparatus 1 to which the present invention is applied.

As shown in FIG. 1, the playback system is configured such that the playback apparatus 1 is connected to a display device 3 via a high definition multimedia interface (HDMI) cable or the like. The playback apparatus 1 is mounted with an optical disc 2 such as BD thereon.

The optical disc 2 is recorded with streams thereon necessary for displaying stereo images (so-called 3D images having two viewpoints).

The playback apparatus 1 is a player for 3D playback of a stream recorded on the optical disc 2. The playback apparatus 1 plays back the stream recorded on the optical disc 2, and prompts the display device 3 such as a television set or the like to display the 3D image obtain by the playback. In the same manner, audio is played back by the playback apparatus 1 and output from a speaker or the like provided in the display device 3.

Various modes have been suggested as a mode for displaying 3D images. Here, as modes for displaying 3D images, a Type 1 display mode and a Type 2 display mode below are employed.

The Type 1 display mode is composed of image data obtained by observing the data of 3D images with a left eye (L image) and image data obtained by observing the data of 3D images with a right eye (R image), and displays 3D images by alternately displaying the L image and R image.

The Type 2 display mode displays 3D images by displaying an L image and an R image generated by using the data of source images which is a source for generating 3D images and the Depth data. The data of 3D images used in the Type 2 display mode is composed of the data of source images and the Depth data which can generate an L image and an R image by being given to the source images.

The Type 1 display mode is a display mode in which eyeglasses are necessary for viewing. The Type 2 display mode is a display mode in which eyeglasses are not necessary for viewing 3D images.

The optical disc 2 is recorded with a stream thereon which enables the display of 3D images in either display mode, Type 1 or Type 2.

As a mode of encoding for recording such a stream on the optical disc 2, for example, H.264 advanced video coding (AVC)/multi-view video coding (MVC) is employed.

### H.264 AVC/MVC Profile

In H.264 AVC/MVC, an image stream called Base view video and an image stream called Dependent view video are defined. Herein below, appropriately, H.264 AVC/MVC is simply referred to as MVC.

FIG. 2 is a diagram illustrating an example of image-capturing.

As shown in FIG. 2, image-capturing is performed by a camera for an L image and a camera for an R Image having the same object as a target. Elementary streams of the movie filmed by the camera for the L image and the camera for the R image are input to an MVC encoder.

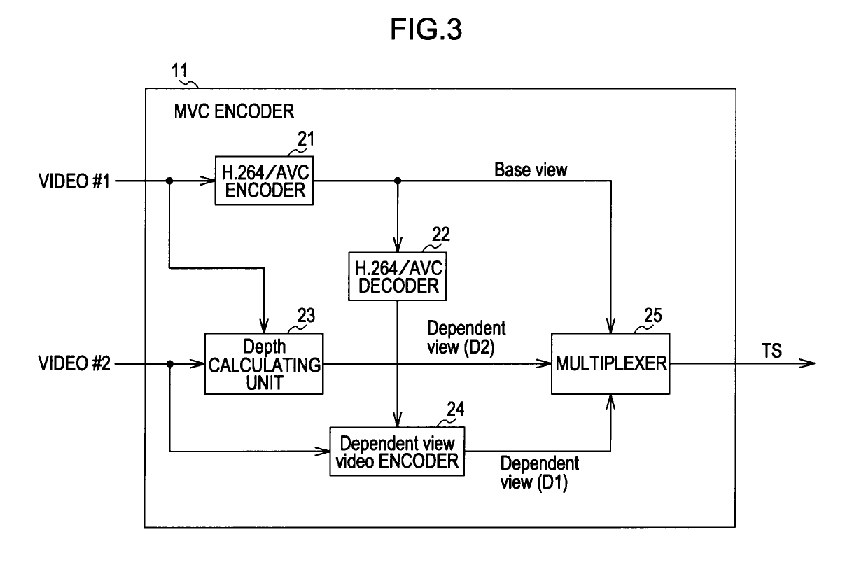

FIG. 3 is a block diagram illustrating an example of a composition of the MVC encoder.

As shown in FIG. 3, an MVC encoder 11 is composed of an H.264/AVC encoder 21, an H.264/AVC decoder 22, a Depth calculating unit 23, a Dependent view video encoder 24, and a multiplexer 25.

The streams of a video #1 filmed by the camera for the L image are input to the H.264/AVC encoder 21 and the Depth calculating unit 23. In addition, the streams of a video #2 filmed by the camera for the R image are input to the Depth calculating unit 23 and the Dependent view video encoder 24. It may be possible that the streams of the video #2 are input to the H.264/AVC encoder 21 and the Depth calculating unit 23, and the streams of a video #1 are input to the Depth calculating unit 23 and the Dependent view video encoder 24.

The H.264/AVC encoder 21 encodes the streams of the video #1 as for example, H.264 AVC/High Profile video stream. The H.264/AVC encoder 21 outputs the AVC view of stream obtained by the encoding to the H.264/AVC decoder 22 and the multiplexer 25 as Base view video stream.

The H.264/AVC decoder 22 decodes the AVC video stream supplied from the H.264/AVC encoder 21, and outputs the streams of the video #1 obtained by the decoding to the Dependent view video encoder 24.

The Depth calculating unit 23 calculates Depth based on the streams of the video #1 and the streams of the video #2, and outputs the Depth data to the multiplexer 25.

The Dependent view video encoder 24 encodes the streams of the video #1 supplied from the H.264/AVC decoder 22 and the streams of the video #2 input from outside, and outputs the Dependent view video stream.

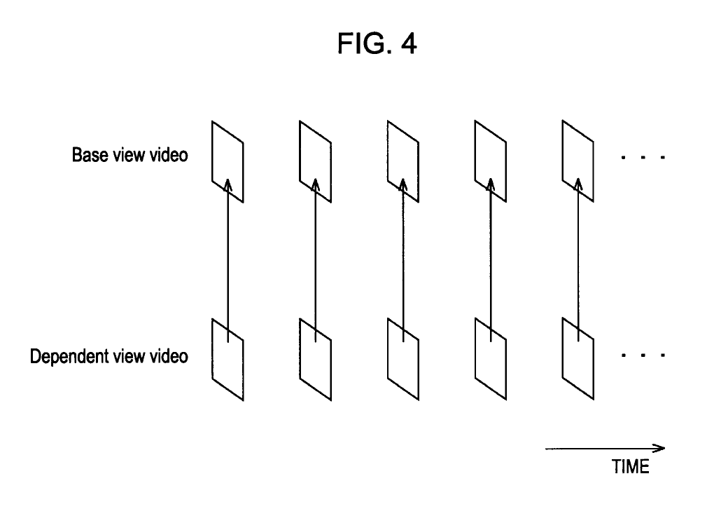

In Base view video, predictive encoding having other streams as a reference image is not allowed, but as shown in FIG. 4, in Dependent view video, predictive encoding having Base view video as a reference image is allowed. For example, when encoding is performed having an L image as Base view video and an R image as Dependent view video, the data amount of Dependent view video stream obtained as the result is smaller than the data amount of Base view video stream.

Furthermore, since the encoding is in H.264/AVC, prediction is performed for Base view video in the time direction. In addition, for Dependent view video, prediction between views and prediction in the time direction are performed. In decoding Dependent view video, it is necessary to finish the decoding of the corresponding Base view video, which is a target for reference during encoding.

The Dependent view video encoder 24 outputs the Dependent view video stream obtained by encoding with use of the prediction between views to the multiplexer 25.

The multiplexer 25 multiplexes Base view video stream supplied from the H.264/AVC encoder 21, Dependent view video stream (Depth data) supplied from the Depth calculating unit 23, and Dependent view video stream supplied from the Dependent view video encoder 24 as, for example, MPEG2 TS. Base view video stream and Dependent view video stream may be multiplexed to one MPEG2 TS, and may be included in separate MPEG2 TS.

The multiplexer 25 outputs the generated TS (MPEG2 TS). The TS output from the multiplexer 25 is recorded on the optical disc 2 in a recording device in addition to other management data, and provided to the playback apparatus 1 in the form of being recorded on the optical disc 2.

When it is necessary to distinguish Dependent view video used together with Base view video in the Type 1 display mode from Dependent view video (Depth) used together with Base view video in the Type 2 display mode, the former is referred to as D1 view video, and the latter is referred to as D2 view video.

In addition, 3D playback in the Type 1 display mode performed by using Base view video and the D1 view video is referred to as B-D1 playback. 3D playback in the Type 2 display mode performed by using Base view video and the D2 view video is referred to as B-D2 playback.

The playback apparatus 1 performs playback by reading Base view video stream and D1 view video stream from the optical disc 2 when B-D1 playback is performed according to an instruction from a user.

In addition, the playback apparatus 1 performs playback by reading Base view video stream and D2 view video stream from the optical disc 2 when B-D2 playback is performed.

Furthermore, the playback apparatus 1 performs playback by reading only Base view video stream from the optical disc 2 when general playback of 2D images is performed.

Since the Base view video stream is AVC video stream encoded in H.264/AVC, in case where a player is for BD format, the Base view video stream is played back and it is possible to display 2D images.

Hereinbelow, description will be provided mainly for a case where Dependent view video is D1 view video. When Dependent view video is simply mentioned, it indicates D1 view video. The D2 view video is recorded on the optical disc 2 and played back in the same way of the D1 view video.

### Example of Composition of TS

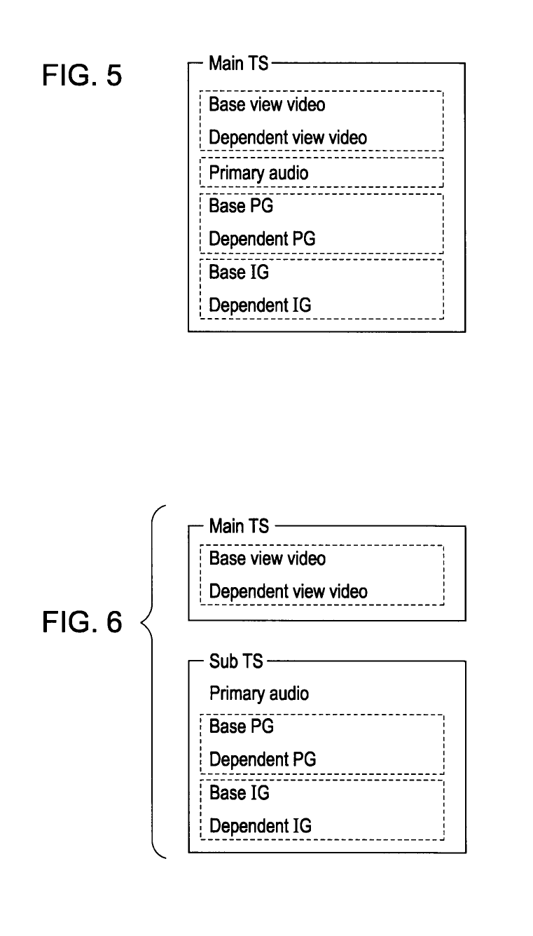

FIG. 5 is a diagram illustrating an example of the composition of TS.

In Main TS of FIG. 5, each stream of Base view video, Dependent view video, Primary audio, Base PG, Dependent PG, Base IG, and Dependent IG is multiplexed. As such, there is a case where Dependent view video stream is included in Main TS with Base view video stream.

On the optical disc 2, Main TS and Sub TS are recorded. The Main TS is TS including at least Base view video stream. The Sub TS is TS that includes a stream other than Base view video stream and is used with the Main TS.

Each of streams is prepared which are Base view and Dependent view for PG and IG to be described later so that the display is possible in three-dimension as in video.

The plane of Base view of PG and IG obtained by decoding each of the streams is displayed by being synthesized with the plane of Base view video obtained by decoding Base view video stream. In the same manner, the plane of Dependent view of PG and IG is displayed by being synthesizing with the plane of Dependent view video obtained by decoding Dependent view video stream.

For example, when Base view video stream the stream of an L image, and Dependent view video stream is the streams of an R image, the Base view stream becomes the stream of graphics of the L image also for PG and IG. In addition, the PG stream and the IG stream of Dependent view becomes the stream of graphics of the R image.

On the other hand, when Base view video stream is the stream of an R image, and Dependent view video stream is the stream of an L image, the stream of Base view becomes the stream of graphics of the R image also for PG and IG. In addition, the PG stream and the IG stream of Dependent view becomes the stream of graphics of the L image.

FIG. 6 is a diagram illustrating an example of another composition of TS.

In the Main TS of FIG. 6, each of streams of Base view video and Dependent view video is multiplexed.

On the other hand, in Sub TS, each of streams of Primary audio, Base PG, Dependent PG, Base IG, and Dependent IG is multiplexed.

As such, there are some cases where a video stream is multiplexed in Main TS and the streams of PG and IG are multiplexed in Sub TS.

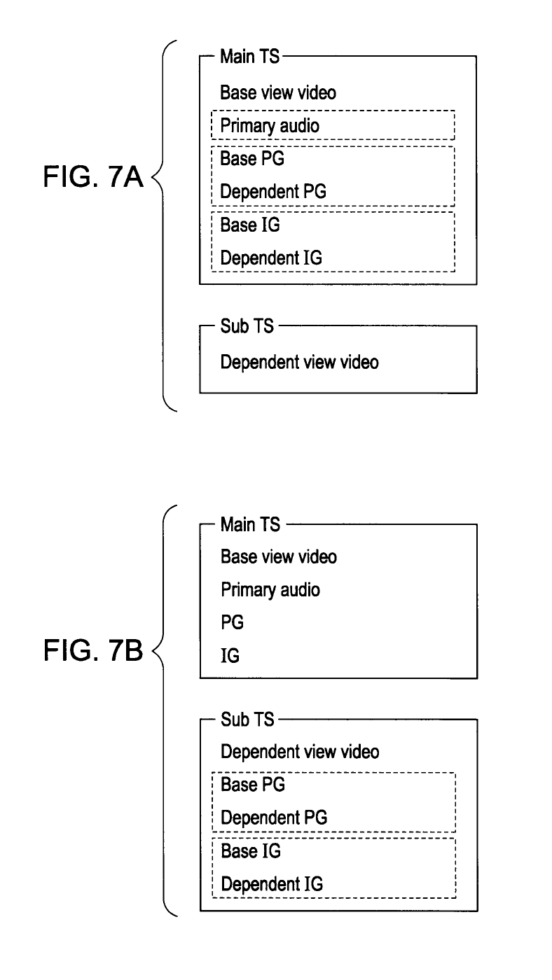

FIGS. 7A and 7B are diagrams illustrating examples of still another composition of TS.

In Main TS of FIG. 7A, each of streams of Base view video, Primary audio, Base PG, Dependent PG, Base IG and Dependent IG is multiplexed.

On the other hand, in Sub TS, Dependent view video stream is included.

As such, the Dependent view video stream is included in a separate TS from the Base view video stream.

In Main TS of FIG. 7B, each of streams of Base view video, Primary audio, PG, and IG is multiplexed. On the other hand, in Sub TS, each of streams of Dependent view video, Base PG, Dependent PG, Base IG, and Dependent IG is multiplexed.

The PG and IG included in the Main TS are streams for 2D playback. The streams included in the Sub TS are streams for 3D playback.

As such, it is possible that the stream of PG and the stream of IG are not shared in 2D playback and 3D playback.

As such, there is a case where the Base view video stream and Dependent view video stream are included in MPEG2 TS. An advantage when the Base view video stream and the Dependent view video stream are included in separate MPEG2 TS will be described.

For example, let's think about the case where a bit rate that enables the multiplexing as one MPEG2 TS is restricted. In this case, when both of the Base view video stream and the Dependent view video stream are included in one MPEG2 TS, it is necessary to lower the bit rate of each stream in order to satisfy the restriction. As a result, the quality of images deteriorates.

By including the streams in different MPEG2 TS, it is not necessary to lower the bit rate and the quality of images does not deteriorate.

### Application Format

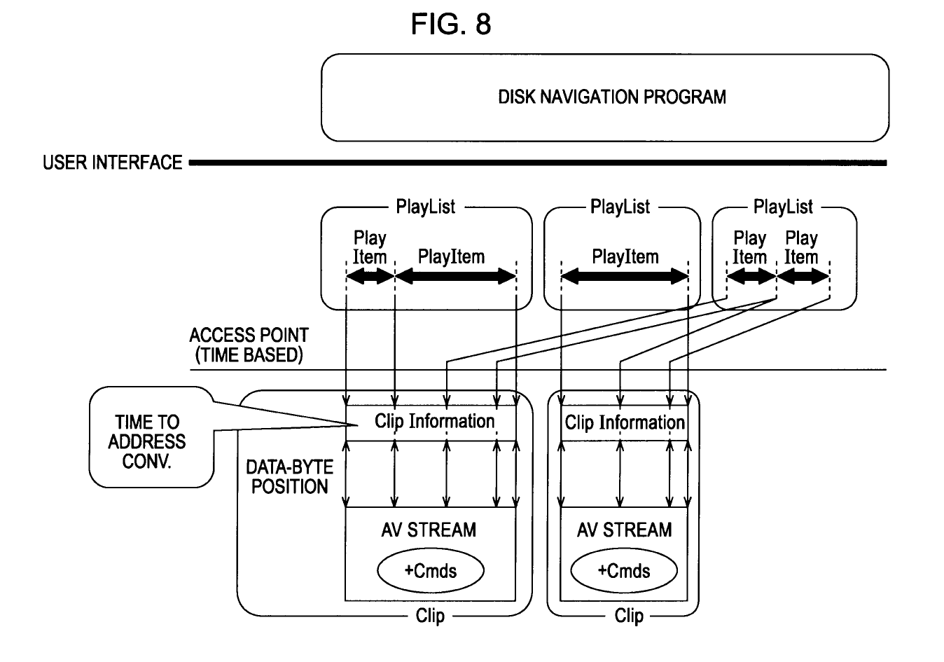

FIG. 8 is a diagram illustrating an example of the management of AV stream by the playback apparatus 1.

The management of AV stream is performed by using 2 layers of PlayList and Clip as shown in FIG. 8. The AV stream may be recorded not only on the optical disc 2 but also a local storage of the playback apparatus 1.

Herein, a pair of Clip Information which is one AV stream and its accompanying information is considered as one object, and referred to as Clip as a whole. Hereinbelow, a file accommodating the AV stream is called an AV stream file. In addition, a file accommodating Clip Information is called a Clip Information file.

The AV stream is developed on a time axis and an access point of each Clip is designated in the PlayList mainly by a time stamp. The Clip Information file is used for locating the address where decoding in the AV stream is supposed to be started.

The PlayList is a gathering of playback zones of the AV stream. One playback zone in the AV stream is called a PlayItem. The PlayItem is expressed by a pair of an IN point and an OUT point of the playback zone on the time axis. The PlayList includes one or plural PlayItems as shown in FIG. 8.

The first PlayList from the left of FIG. 8 includes two PlayItems, and the first half and the latter half of the AV stream included in the Clip in the left side are each referred to by the two PlayItems.

The second PlayList from the left includes one PlayItem, and the entire AV stream included in the Clip in the right side is referred to by the PlayItem.

The third PlayList from the left includes two PlayItems, and a part of the AV stream included in the Clip in the left side and a part of the AV stream included in the Clip in the right side are each referred to by the two PlayItems.

For example, when the PlayItem in the left side included in the first PlayList from the left is designated as a playback target by a disc navigation program, the first half of the AV stream included in the Clip in the left side and referred to by the PlayItem is played back. As such, the PlayList is used as playback control information for controlling the playback of the AV stream.

In the PlayList, a playback path made by the arrangement of one or more PlayItems is called a Main Path.

Furthermore, in the PlayList, a playback path constituted by the arrangement of one or more SubPlayItems in parallel with the Main Path is called a Sub Path.

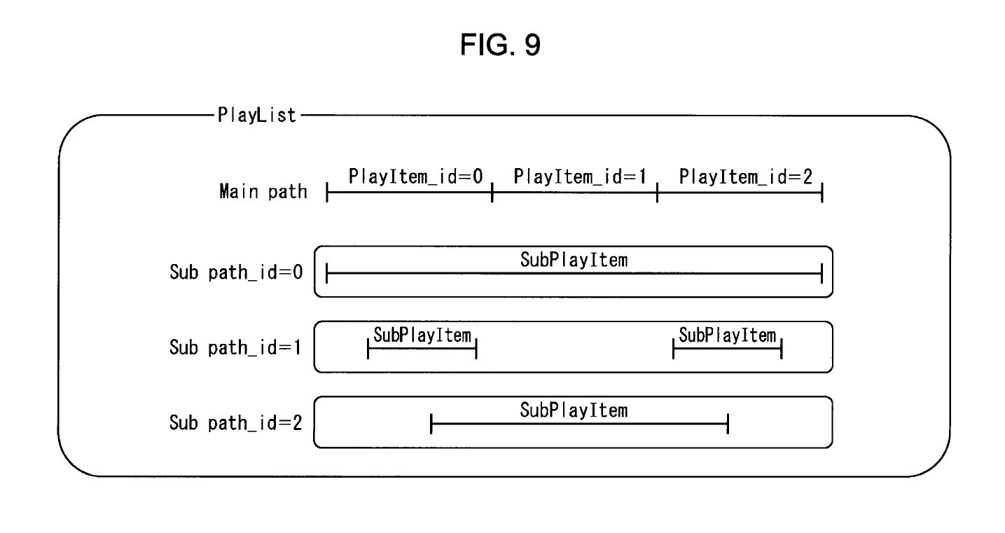

FIG. 9 is a diagram illustrating the structure of a Main Path and a Sub Path.

A PlayList can have one Main Path and one or more Sub Paths.

The Base view video stream described above is managed as a stream that the PlayItem constituting the Main Path refers to. In addition, the Dependent view videos stream is managed as a stream that the SubPlayItem constituting the Sub Path refers to.

The PlayList of FIG. 9 has one Main Path and three Sub paths constituted by the arrangement of three PlayItems.

The PlayItems constituting the Main Path is set with IDs orderly from the beginning. The Sub Paths are also set with ID including Subpath_id=0, Subpath_id=1, and Subpath_id=2 orderly from the beginning.

In the example of FIG. 9, one SubPlayItem is included in the Sub Path of Subpath_id=0, and two SubPlayItems are included in the Sub Path of Subpath_id=1. In addition, one SubPlayItem is included in the Sub Path of Subpath_id=2.

In the Clip AV stream that one PlayItem refers to, at least a video stream (main image data) is included.

In addition, in the Clip AV stream, one or more audio streams played back at the same timing as the video stream included in the Clip AV stream may be or may not be included.

In the Clip AV stream, one or more streams of bitmap subtitle data (Presentation Graphic (PG)) played back in synchronized with the video stream included in the Clip AV stream may be or may not be included.

In the Clip AV stream, one or more streams of Interactive Graphic (IG) played back in synchronized with the same video stream included in the Clip AV stream may be or may not be included. The stream of IG is used for displaying graphic such as a button or the like operated by a user.

In the Clip AV stream that one PlayItem refers to, the video stream, zero or more audio streams played back in synchronized with the video stream, zero or more PG streams, and zero or more IG streams are multiplexed.

In addition, one SubPlayItem refers to a video stream, an audio stream, a PG stream, or the like that is a stream (other stream) different from the Clip AV stream that the PlayItem refers to.

The management of the AV stream using the PlayList, PlayItem, and SubPlayItem is described in, for example, Japanese Unexamined Patent Application Publication No. 2008-252740 and Japanese Unexamined Patent Application Publication No. 2005-348314.

### Structure of Directory

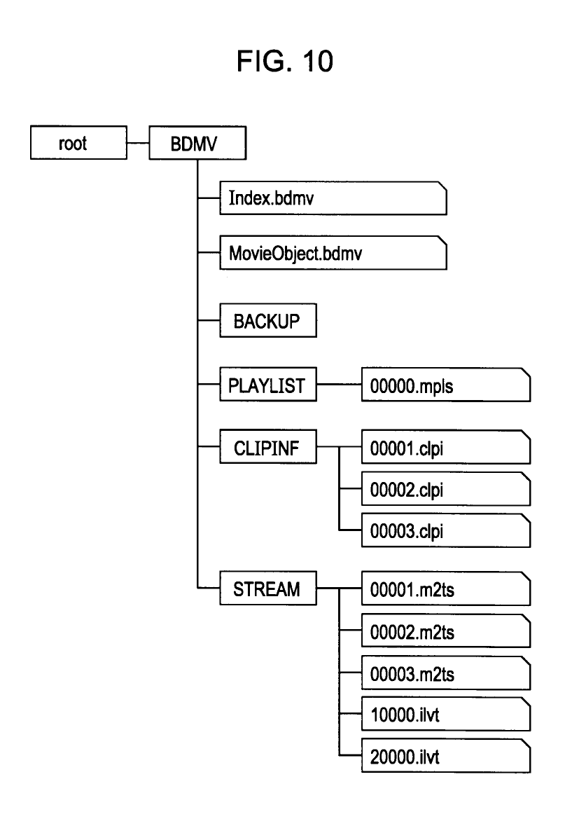

FIG. 10 is a diagram illustrating an example of the management structure for files recorded on the optical disc 2.

As shown in FIG. 10, files are managed hierarchically with the directory structure. One root directory is created on the optical disc 2. The lower part of the root directory is a range to be managed with one recording and playback system.

A BDMV directory is set below the root directory.

An index file, which is a file named as “Index.bdmv”, and a MovieObject file, which is a file named as “MovieObject.bdmv” are accommodated just below the BDMV directory.

A BACKUP directory, a PLAYLIST directory, a CLIPINF directory, and a STREAM directory are provided below the BDMV directory.

PlayList files which are files describing a PlayList are accommodated in the PLAYLIST directory. In each of PlayList files, a name made by combining a 5-digit number and an extension “.mpls” is set. In one PlayList file shown in FIG. 10, a file name of “00000.mpls” is set.

Clip Information files are accommodated in the CLIPINF directory. In each of the Clip Information files, a name made by combining a 5-digit number and an extension “.clpi” is set.

In three Clip Information files of FIG. 10, file names of “00001.clpi”, “00002.clpi”, and “00003.clpi” are set. Hereinafter, a Clip Information file is appropriately referred to as a clpi file.

For example, a clip file of “00001.clpi” is a file describing information on the Clip of Base view video.

The clpi file of “00002.clpi” is file describing information on the Clip of D2 view video.

The clpi file of “00003.clpi” is a file describing information on the Clip of D1 view video.

Stream files are accommodated in the STREAM directory. In each of the stream files, a name made by combining a 5-digit number and an extension of “.m2ts” or a name made by combining a 5-digit number and an extension of “.ilvt” is set. Hereinafter, a file set with the extension of “.m2ts” is appropriately referred to as an m2ts file. In addition, a file set with the extension of “.ilvt” is referred to as an ilvt file.

The m2ts file of “00001.m2ts” is a file for 2D playback, and by designating the file, reading of Base view video stream is performed.

The m2ts file of “00002.m2ts” is a file of D2 view video stream, and the m2ts file of “00003.m2ts” is a file of D1 view video stream.

The ilvt file of “10000.ilvt” is a file for B-D1 playback, and by designating the file, reading of Base view video stream and D1 view video stream is performed.

The ilvt file of “20000.ilvt” is a file for B-D2 playback, and by designating the file, reading of Base view video stream and D2 view video stream is performed.

In addition to the directories shown in FIG. 10, directories accommodating files of audio streams are provided below the BDMV directory.

### Syntax of Each Data

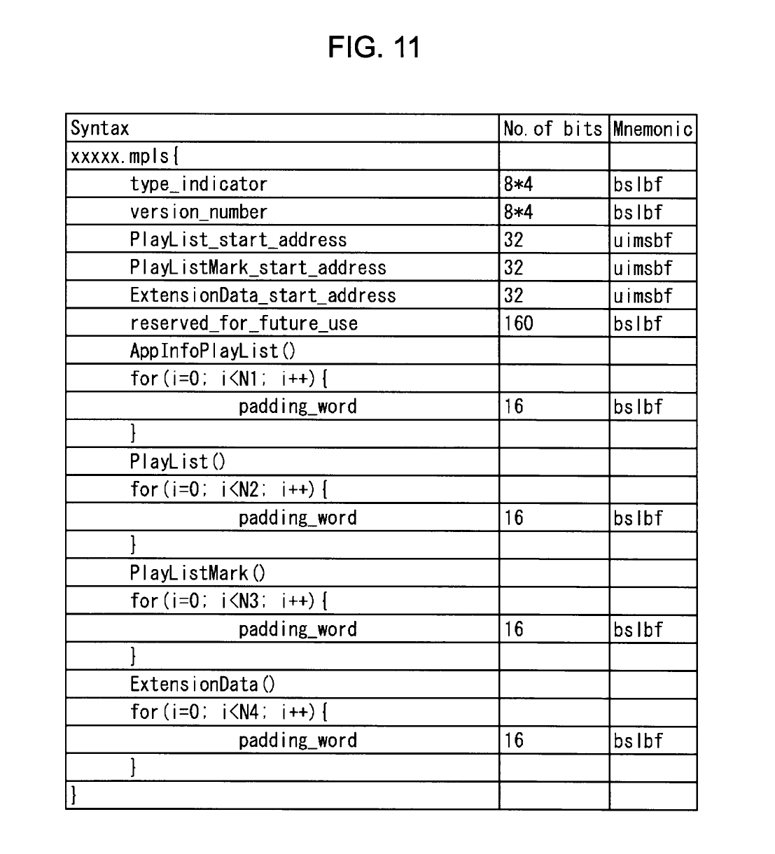

FIG. 11 is a diagram illustrating the syntax of a PlayList file.

The PlayList file is a file set with the extension of “.mpls” accommodated in the PLAYLIST directory of FIG. 10.

The type_indicator in FIG. 11 indicates a kind of a file named “xxxxx.mpls”.

The version_number indicates a version number of “xxxx.mpls”. The version_number includes a 4-digit number. For example, a PlayList file for 3D playback is set with “0240” indicating “3D Spec version”.

The PlayList_start_address indicates a base address of PlayList( ) with a unit of the number of relative bytes from the leading byte of the PlayList file.

The PlayListMark_start_address indicates a base address of PlayListMark( ) with a unit of the number of relative bytes from the leading byte of the PlayList file.

The ExtensionData_start_address indicates a base address of ExtensionData( ) with a unit of the number of relative bytes from the leading byte of the PlayList file.

Below the ExtensionData_start_address, 160-bit reserved_for_future_use is included.

In the AppInfoPlayList( ) a parameter relating to playback control of the PlayList, such as playback limit or the like, is accommodated.

In the PlayList( ) a parameter relating to Main Path, Sub Path or the like is accommodated. The contents of the PlayList( ) will be described later.

In the PlayListMartk( ) information is accommodated which is mark information of the PlayList, in other words, information about a mark, which is a jump point in a user operation or command instructing chapter jump or the like.

The ExtensionData( ) is configured such that private data can be inserted thereinto.

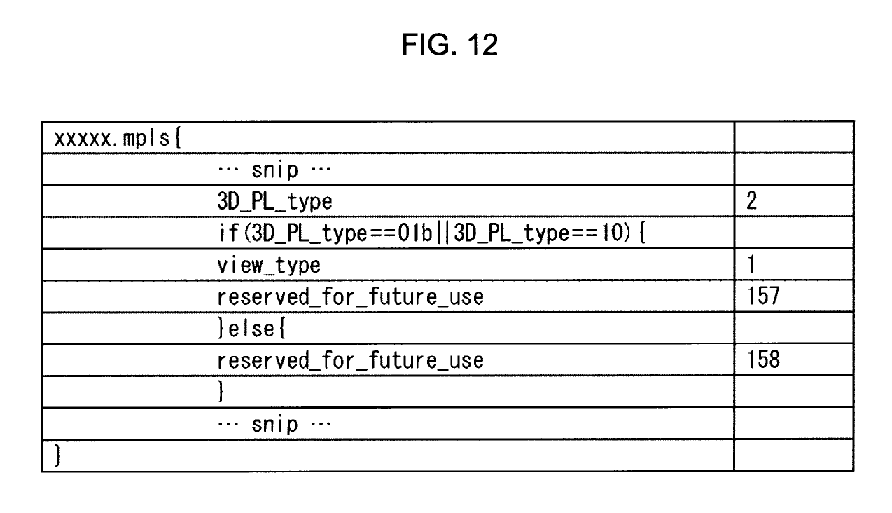

FIG. 12 is a diagram illustrating a specific example of description in the PlayList file.

As shown in FIG. 12, 2-bit 3D_PL_type and 1-bit view_type are described in the PlayList file.

The 3D_PL_type indicates the kind of the PlayList.

The view_type indicates whether the Base view video stream of which playback is managed by the PlayList is the stream of an L image (L view) or the stream of an R image (R view).

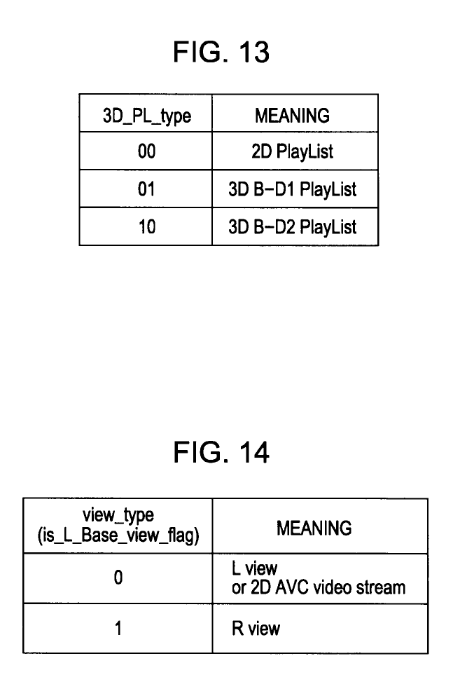

FIG. 13 is a diagram illustrating the meaning of values of 3D_PL_type.

00 as a value of the 3D_PL_type indicates that the PlayList is for 2D playback.

01 as a value of the 3D_PL_type indicates that the PlayList is for B-D1 playback in 3D playback.

10 as a value of the 3D_PL_type indicates that the PlayList is for B-D2 playback in 3D playback.

For example, when the value of the 3D_PL_type is 01 or 10, information of 3D PlayList is registered in ExtenstionData( ) of a PlayList file. For example, information relating to reading of Base view video stream and Dependent view video stream from the optical disc 2 is registered as the information of 3DPlayList.

FIG. 14 is a diagram illustrating the meaning of values of view_type.

0 as a value of the view_type indicates that the Base view video stream is the stream of L view when 3D playback is performed. The value indicates that the Base view video stream is an AVC video stream when 2D playback is performed.

1 as a value of the view_type indicates that the Base view video stream is the stream of R view.

By describing the view_type in the PlayList file, the playback apparatus 1 is able to identify whether the Base view video stream is the stream of the L view or the stream of the R view.

For example, when a video signal is output to the display device 3 via an HDMI cable, it is considered that the playback apparatus 1 is necessary to perform the output after distinguishing the signal of the L view and the signal of the R view.

By being able to identify whether the Base view video stream is the stream of the L view or the stream of the R view, the playback apparatus 1 is able to distinguish and output the signal of the L view and the signal of the R view.

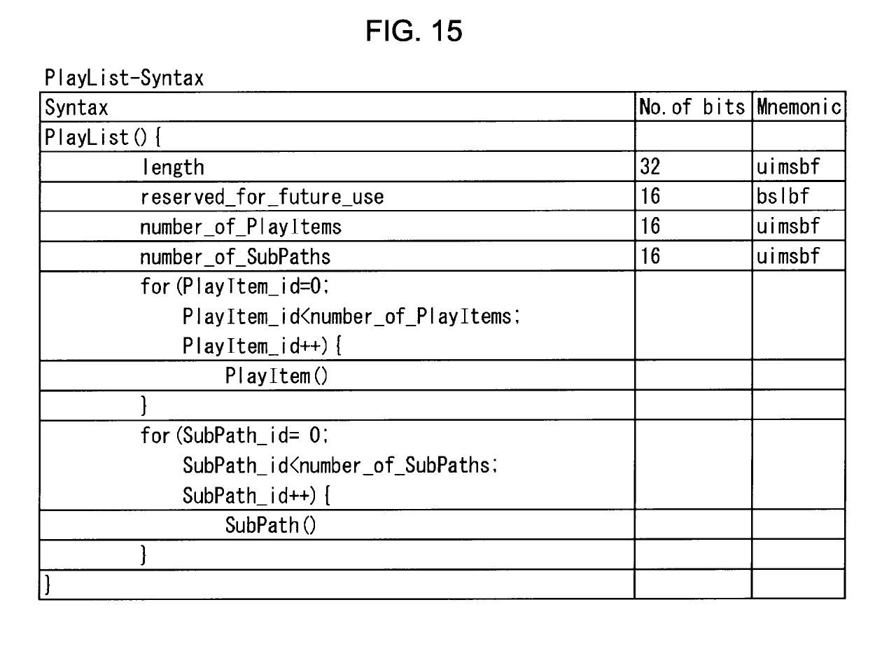

FIG. 15 is a diagram illustrating the syntax of the PlayList( ) in FIG. 11.

The length is a 32-bit unsigned integer indicating the number of bytes from the immediate next of the length field to the final end of the PlayList( ). In other words, the length indicates the number of bytes from the reserved_for_future_use to the final end of the PlayList.

Below the length, 16-bit reserved_for_future_use is prepared.

The number_of_PlayItems is a 16-bit field indicating the number of PlayItems in the PlayList. In case of the example in FIG. 9, the number of PlayItems is three. The value of PlayItem_id is allocated from 0 in the order in which PlayItem( ) appears in the PlayList. For example, PlayItem_id=0, 1, and 2 are allocated in FIG. 9.

The number_of_SubPaths is a 16-bit field indicating the number of Sub Paths in the PlayList. In case of the example in FIG. 9, the number of Sub Paths are three. The value of SubPath_id is allocated from 0 in the order in which SubPath( ) appears in the PlayList. For example, Subpath_id=0, 1, and 2 are allocated in FIG. 9. In the for statement thereafter, the PlayItem( ) is referred to as many as the number of PlayItems and the SubPath( ) is referred to as many as the number of Sub Paths.

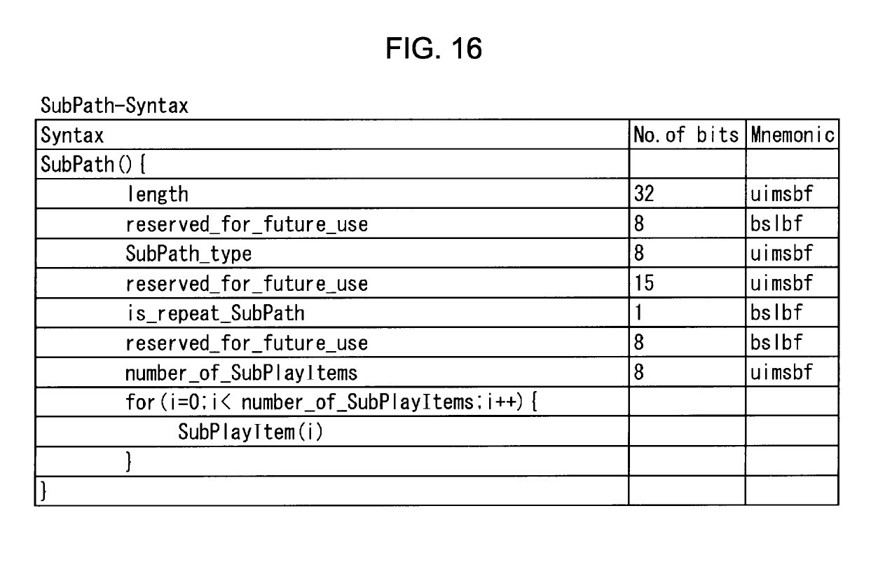

FIG. 16 is a diagram illustrating the syntax of the SubPath( ) in FIG. 15.

The length is a 32-bit unsigned integer indicating the number of bytes from the immediate next of the length field to the final end of the Sub Path( ). In other words, the length indicates the number of bytes from reserved_for_future_use to the final end of the PlayList.

Below the length, 16-bit reserved_for_future_use is prepared.

The SubPath_type is a 8-bit field indicating the kind of application of the Sub Path. The SubPath_type is used, for example, for indicating the kind such as whether the Sub Path is audio, bitmap subtitles or text subtitles.

Below the SubPath_type, 15-bit reserved_for_future_use is prepared.

The is_repeat_SubPath is a 1-bit field for designating the playback method of the Sub Path, and indicates whether the playback of the Sub Path is to be repeated between the playback of the Main Path or the playback of the Sub Path is to be performed once. For example, the is_repeat_SubPath is used when playback timings are different for the Clip that the Main Path refers to and the Clip that the Sub Path refers to (when it is used as a path of video in which the Main Path is a path of a slide show for still images and the Sub Path is BGM, or the like).

Below the Is_repeat_SubPath, 8-bit reserved_for_future_use is prepared.

The number_of_SubPlayItems is an 8-bit field indicating the number of (entry number) of SubPlayItems in one Sub Path. For example, the number_of_SubPlayItems of the SubPlayItem of SubPath_id=0 in FIG. 9 is 1, and the number_of_SubPlayItems of SubPlayItem of SubPath_id=1 is 2. In the for statement thereafter, the SubPlayItem( ) is referred to as many as the number of SubPlayItems.

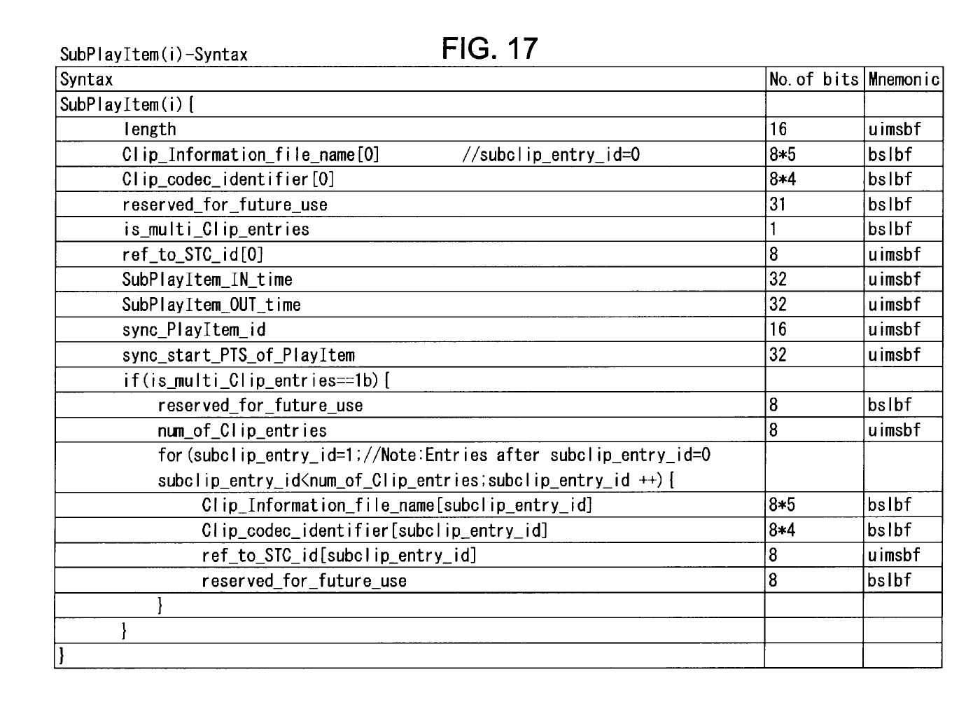

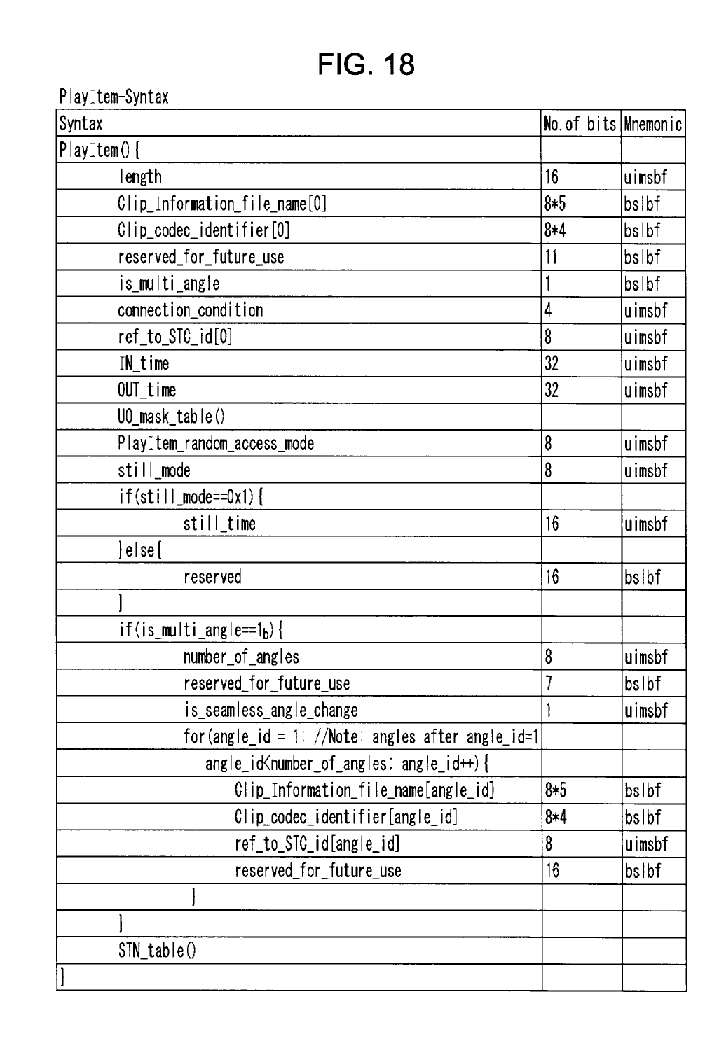

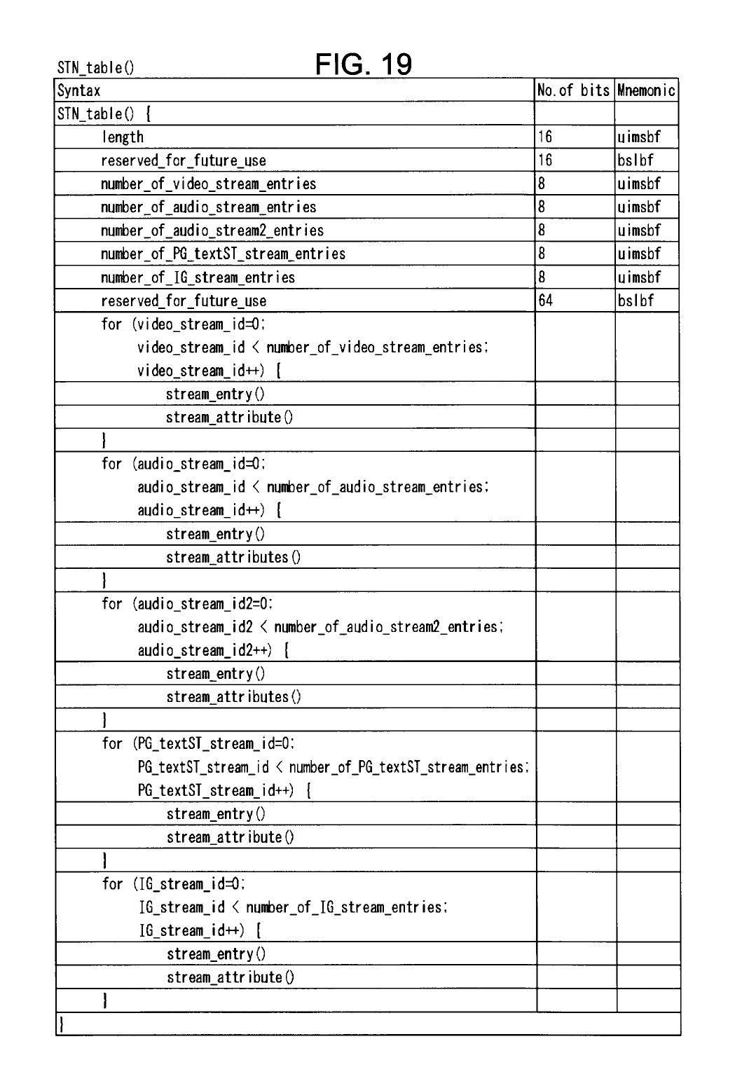

FIG. 17 is a diagram illustrating the syntax of the SubPlayItem(i) in FIG. 16.

The length is a 16-bit unsigned integer indicating the number of bytes from the immediate next of the length field to the final end of the Sub playItem( ).

The SubPlayItem(i) in FIG. 17 is described with being divided into a case where the SubPlayItem refers to one Clip and a case where the SubPlayItem refers to a plurality of Clips.

The case where the SubPlayItem refers to one Clip will be described.

The Clip_Information_file_name[0] indicates the Clip to be referred to.

The Clip_codec_identifier[0] indicates a codec mode of the Clip. Below the Clip_codec_identifier[0], reserved_for_future_use is included.

The is_multi_Clip_entries is a flag indicating the existence of registration of a multi Clip. When the flag of the is_multi_Clip_entries is set, the syntax for a case when the SubPlayItem refers to a plurality of Clips is referred to.

The ref_to_STC_id[0] is information relating to an STC discontinuous point (a discontinuous point of a system time base).

The SubPlayItem_IN_time indicates a starting position of the playback zone of the Sub Path, and the SubPlayItem_OUT_time indicates an ending position.

The sync_PlayItem_id and the sync_start_PTS_of_PlayItem indicate a time when the playback of the Sub Path is started on the time axis of the Main Path.

The SubPlayItem_IN_time, SubPlayItem_OUT_time, sync_PlayItem_id, and sync_start_PTS_of_PlayItem are used together in the Clip that the SubPlayItem refers to.

A case will be described where “if (is_multi_Clip_entries==1b” and the SubPlayItem refers to a plurality of Clips.

The num_of_Clip_entries indicates the number of Clips to be referred to. The number of Clip_Information_file_name[SubClip_entry_id] designates the number of Clips excluding the Clip_Information_file_name[0].

The Clip_codec_identifier[SubClip_entry_id] indicates a codec mode of the Clip.

The ref_to_STC_id[SubClip_entry_id] is information on an STC discontinuous point (a discontinuous point of a system time base). Below the ref_to_STC_id[SubClip_entry_id], the reserved_for_future_use is included.

FIG. 18 is a diagram illustrating the syntax of the PlayItem( ) in FIG. 15.

The length is a 16-bit unsigned integer indicating the number of bytes from the immediate next of the length field to the final end of the PlayItem( ).

The Clip_Information_file_name[0] indicates the name of a Clip Information file of the Clip that the PlayItem refers to. Furthermore, the file name of an mt2s file including the Clip, and the file name of a Clip Information file corresponding thereto are included with a same 5-digit number.

The Clip_codec_identifier[0] indicates a codec mode of the Clip. Below the Clip_codec_identifier[0], reserved_for_future_use is included. Below the reserved_for_future_use, is_multi_angle, and connection_condition are included.

The ref_to_STC_id[0] is information of an STC discontinuous point (a discontinuous point of a system time base).

The IN_time indicates a starting point of the playback zone of the PlayItem, and the OUT_time indicates the ending point thereof.

Below the OUT_time, UO_mask_table( ), PlayItem_random_access_mode, and still_mode are included.

In the STN_table( ) the information of AV stream that a target PlayItem refers to is included. In addition, when there is Sub Path to be played back in association with the target PlayItem, the information of AV stream that SubPlayItem forming the Sub Path is also included.

FIG. 19 is a diagram illustrating the syntax of the STN_table( ) in FIG. 18.

The STN_table( ) is set as an attribute of the PlayItem.

The length is a 16-bit unsigned integer indicating the number of bytes from the immediate next of the length field to the final end of the STN_table( ). Below the length, 16-bit reserved_for_future_use is prepared.

The number_of_video_stream_entries indicates the number of streams that is given with the video_stream_id and gains an entry (registered) in the STN_table( ).

The video_stream_id is information for identifying a video stream. For example, the Base view video stream is specified by video_stream_id.

The ID of the Dependent view video stream may be defined in the STN_table( ) and may be acquired by calculating such as addition of a predetermined value to the ID of the Base view video stream.

The video_stream_number is a video stream number shown to a user that is used for video switching.

The number_of_audio_stream_entries indicates the number of streams of a first audio stream that is given with audio_stream_id and gains an entry in the STN_table( ). The audio_stream_id is information for identifying an audio stream, and the audio_stream_number is an audio stream number shown to a user that is used for audio switching.

The number_of_audio_stream2_entries indicates the number of streams of a second audio stream that is given with audio_stream_id2 and gains an entry in the STN_table( ). The audio_stream_id2 is information for identifying an audio stream, and the audio_stream_number is an audio stream number shown to a user that is used for audio switching. In this example, it is possible to switch to audio to be played back.

The number_of_PG_txtST_stream_entries indicates the number of streams that is given with PG_txtST_stream_id and gains an entry in the STN_table( ). Among these, the PG stream obtained by subjecting the bitmap subtitles to run-length encoding and a text subtitle file (txtST) gain entries. The PG_txtST_stream_id is information for identifying a subtitle stream and the PG_txtST_stream_number is a subtitle stream number shown to a user that is used for subtitle switching.

The number_of_IG_stream_entries indicates the number of streams that is given with IG_stream_id and gains an entry in the STN_table( ). Among these, an IG stream gains an entry. The IG_stream_id is information for identifying the IG stream, and the IG_stream_number is a graphic stream number shown to a user that is used in graphic switching.

The IDs of Main TS and Sub TS are also registered in the STN_table( ). The fact that the IDs are not elementary stream but IDs of TS is described in the stream_attribute( ).

### Example of Composition of Playback Apparatus 1

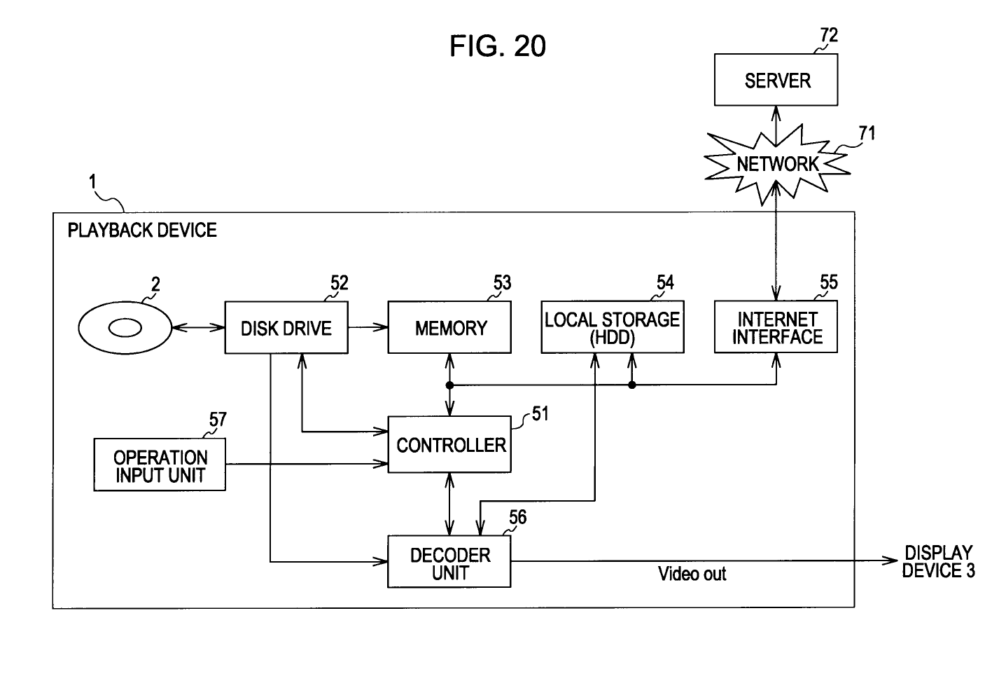

FIG. 20 is a block diagram illustrating an example of the composition of the playback apparatus 1.

A controller 51 executes a control program prepared in advance, and controls the operation of the entire playback apparatus 1.

For example, the controller 51 controls a disk drive 52, and reads a PlayList file for 3D playback. In addition the controller 51 reads Main TS and SubTS based on the ID registered in the STN_table and supplies to a decoder unit 56.

The disk drive 52 reads data from the optical disc 2 according to the control of the controller 51 and outputs the read data to the controller 51, a memory 53, or the decoder unit 56.

The memory 53 appropriately stores data or the like necessary for the controller 51 to execute various processes.

A local storage 54 includes, for example, a hard disk drive (HDD). The local storage 54 has Dependent view video stream, or the like downloaded from a server 72 recorded therein. The stream recorded in the local storage 54 appropriately supplied to the decoder unit 56.

An Internet interface 55 performs communication with the server 72 via a network 71 according to the control of the controller 51, and supplies data downloaded from the server 72 to the local storage 54.

Data obtained by updating the data recorded on the optical disc 2 are downloaded from the server 72. With the combined use of the downloaded Dependent view video stream and the Base view video stream recorded on the optical disc 2, it is possible to realize 3D playback of content different from that in the optical disc 2. When the Dependent view video stream is downloaded, the content of the PlayList is appropriately updated.

The decoder unit 56 decodes a stream supplied from the disk drive 52 or the local storage 54, and outputs an obtained video signal to the display device 3. An audio signal also is output to the display device 3 via a predetermined path.

An operation input unit 57 includes input devices such as a button, a key, a touch panel, a jog dial, a mouse and the like and receiving units that receive signals such as infrared ray transmitted from a predetermined remote commander. The operation input unit 57 detects the operation of a user and supplies signals indicating the content of the detected operation to the controller 51.

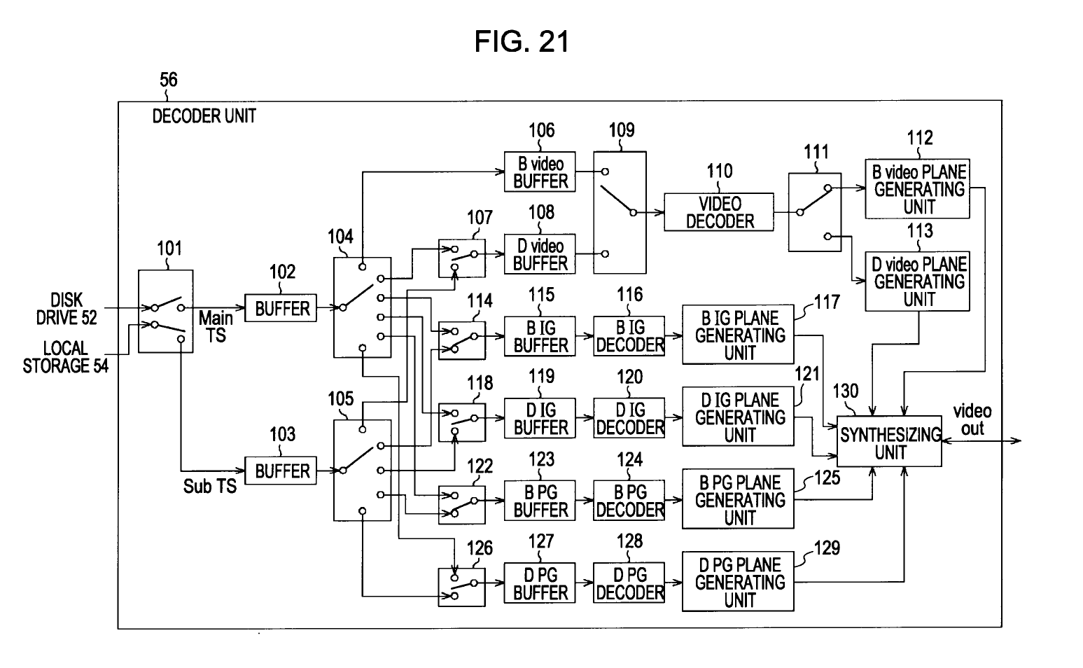

FIG. 21 is a diagram illustrating an example of the composition of the decoder unit 56.

FIG. 21 shows the composition to perform a processing of a video signal. In the decoder unit 56, a decoding processing of an audio signal is also performed. The result of the decoding processing performed for the audio signal is output to the display device 3 via a path not shown in the drawing.

A PID filter 101 identifies whether the TS supplied from the disk drive 52 or the local storage 54 is the Main TS or the Sub TS based on the PID of a packet forming the TS or the ID of a stream, or the like. The PID filter 101 outputs the Main TS to a buffer 102 and outputs the Sub TS to a buffer 103.

A PID filter 104 sequentially reads packets of the Main TS stored in the buffer 102, and distributes the packets based on the PID.

For example, the PID filter 104 outputs a packet forming the Base view video stream included in the Main TS to a B video buffer 106, and outputs a packet forming the Dependent view video stream to a switch 107.

Furthermore, the PID filter 104 outputs a packet forming the Base IG stream included in the Main TS to a switch 114, and outputs a packet forming the Dependent IG stream to a switch 118.

The PID filter 104 outputs a packet forming the Base PG stream included in the Main TS to a switch 122 and outputs a packet forming the Dependent PG stream to a switch 126.

As described above with reference to FIG. 5, there is a case where the streams of the Base view video, the Dependent view video, the Base PG, the Dependent PG, the Base IG, and the Dependent IG are multiplexed in the Main TS.

A PID filter 105 sequentially reads packets of the Sub TS stored in the buffer 103 and distributes the packets based on the PID.

For example, the PID filter 105 outputs a packet forming the Dependent view video stream included in the Sub TS to a switch 107.

Furthermore, the PID filter 105 outputs a packet forming the Base IG stream included in the Sub TS to the switch 114 and outputs a packet forming the Dependent IG stream to the switch 118.

The PID filter 105 outputs a packet forming the Base PG stream included in the Sub TS to the switch 122 and outputs a packet forming the Dependent PG stream to the switch 126.

As described above with reference to FIG. 7, there is a case where the Dependent view video stream is included in the Sub TS. In addition, as described above with reference to FIG. 6, there is a case where the streams of the Base PG, the Dependent PG, the Base IG, and the Dependent IG are multiplexed in the Sub Ts.

The switch 107 outputs the packet forming the Dependent view video stream supplied from the PID filter 104 or the PID filter 105 to a D video buffer 108.

A switch 109 sequentially reads a packet of the Base view video stored in a B video buffer 106 and a packet of the Dependent view video stored in the D video buffer 108 according to time information that defines the timing for decoding. For example, the same time information is set in a packet accommodating data of pictures of the Base view video and a packet accommodating data of pictures of the Dependent view video.

The switch 109 outputs the packet read from the B video buffer 106 or the D video buffer 108 to a video decoder 110.

The video decoder 110 decodes the packet supplied from the switch 109 and outputs the data of the Base view video or the Dependent view video obtained from the decoding to a switch 111.

The switch 111 outputs the data obtained by decoding the packet of the Base view video to a B video plane generating unit 112 and outputs the data obtained by decoding the packet of the Dependent view video to a D video plane generating unit 113.

The B video plane generating unit 112 generates the plane of the Base view video based on the data supplied from the switch 111 and outputs to a synthesizing unit 130.

The D video plane generating unit 113 generates the plane of the Dependent view video based on the data supplied from the switch 111 and outputs to the synthesizing unit 130.

A switch 114 outputs the packet forming the Base IG stream supplied from the PID filter 104 or the PID filter 105 to a B IG buffer 115.

A B IG decoder 116 decodes the packet forming the Base IG stream stored in the B IG buffer 115 and outputs the data obtained from the decoding to a B IG plane generating unit 117.

The B IG plane generating unit 117 generates the plane of the Base IG based on the data supplied from the B IG decoder 116 and outputs the synthesizing unit 130.

The switch 118 outputs the packet forming the Dependent IG stream supplied from the PID filter 104 or the PID filter 105 to a D IG buffer 119.

A D IG decoder 120 decodes the packet forming the Dependent IG stream stored in the D IG buffer 119 and outputs the data obtained by the decoding to a D IG plane generating unit 121.

The D IG plane generating unit 121 generates the plane of the Dependent IG based on the data supplied from the D IG decoder 120 and outputs to the synthesizing 130.

The switch 122 outputs the packet forming the Base PG stream supplied from the PID filter 104 or the PID filter 105 to a B PG buffer 123.

A B PG decoder 124 decodes the packet forming the Base PG stream stored in the B PG buffer 123 and outputs the data obtained by the decoding to a B PG plane generating unit 125.

The B PG plane generating unit 125 generates the plane of the Base PG based on the data supplied from the B PG decoder 124 and outputs to the synthesizing 130.

The switch 126 outputs the packet forming the Dependent PG stream supplied from the PID filter 104 or the PID filter 105 to a D PG buffer 127.

A D PG decoder 128 decodes the packet forming the Dependent PG stream stored in the D PG buffer 127 and outputs the data obtained by the decoding to a D PG plane generating unit 129.

The D PG plane generating unit 129 generates the plane of the Dependent PG based on the data supplied from the D PG decoder 128 and outputs to the synthesizing unit 130.

The synthesizing unit 130 synthesizes the plane of the Base view video supplied from the B video plane generating unit 112, the plane of the Base IG supplied from the B IG plane generating unit 117, and the plane of the Base PG supplied from the B PG plane generating unit 125 in an overlapping manner in a predetermined order, and generates a plane of the Base view.

In addition, the synthesizing unit 130 synthesizes the plane of the Dependent view video supplied from the D video plane generating unit 113, the plane of the Dependent IG supplied from the D IG plane generating unit 121, and the plane of the Dependent PG supplied from the D PG plane generating unit 129 in an overlapping manner in a predetermined order, and generates a plane of the Dependent view.

The synthesizing unit 130 outputs the data of the plane of the Base view and the data of the plane of the Dependent view. Video data output from the synthesizing unit 130 is output to the display device 3 and 3D display is performed by displaying the plane of the Base view and the plane of the Dependent view in an alternate manner.

### First Example of Transport Stream-System Target Decoder (T-STD)

Herein, the decoder and the peripheral composition will be described from the composition shown in FIG. 21.

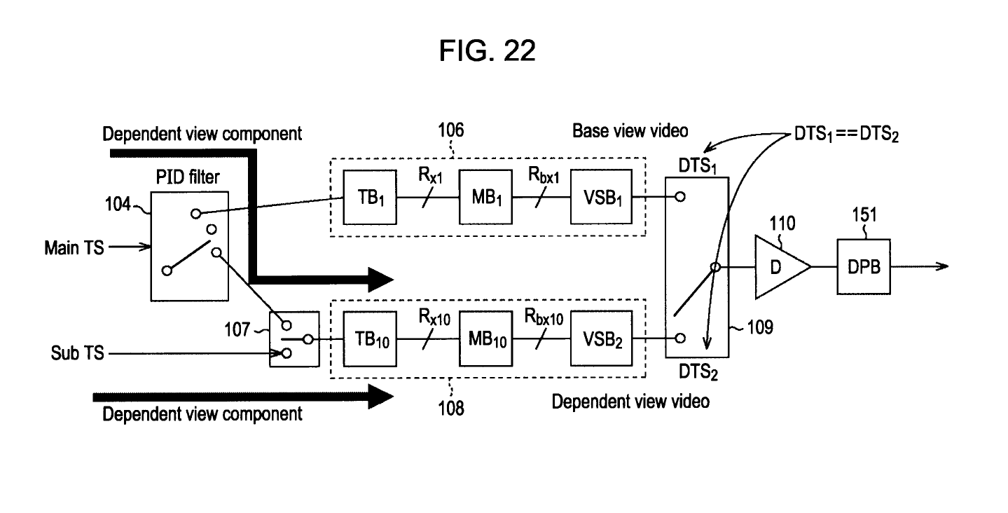

FIG. 22 is a diagram illustrating a composition for performing a process of a video stream.

In FIG. 22, the same components as those in FIG. 21 are given with the same reference numerals. FIG. 22 shows the PID filter 104, the B video buffer 106, the switch 107, the D video buffer 108, the switch 109, the video decoder 110, and a decoded picture buffer (DPB) 151. In the latter part of the video decoder 110, a DPB 151 is provided which stores data of a decoded picture, but is not shown in FIG. 21.

The PID filter 104 outputs the packet forming the Base view video stream included in the Main TS to the B video buffer 106, and outputs the packet forming the Dependent view video stream to the switch 107.

For example, PID=0 is allotted to the packet forming the Base view video stream as a fixed value of the PID. In addition in the packet forming the Dependent view video stream, a fixed value other than 0 is allotted as a PID.

The PID filter 104 outputs the packet where the PID=0 is described in a header to the B video buffer 106 and outputs the packet where the PID other than 0 is described in a header to the switch 107.

The packet output to the B video buffer 106 is stored in a VSB₁ via a Transport Buffer (TB)₁, and a Multiplexing Buffer (MB)₁. In the VSB₁, the data of an elementary stream of the Base view video is stored.

Not only the packet output from the PID filter 104 but also the packet forming the Dependent view video stream extracted from the Sub TS in the PID filter 105 of FIG. 21 are supplied to the switch 107.

When the packet forming Dependent view video stream is supplied from the PID filter 104, the switch 107 outputs the packet to the D video buffer 108.

Furthermore, when the packet forming Dependent view video stream is supplied from the PID filter 105, the switch 107 outputs the packet to the D video buffer 108.

The packet output to the D video buffer 108 is stored in a VSB₂ via a TB₂ and MB₂. The VSB₂ stores the data of an elementary stream of the Dependent view video.

The switch 109 sequentially reads the packet of the Base view video stored in the VSB₁ of the B video buffer 106 and the packet of the Dependent view video stored in the VSB₂ of the D video buffer 108 and outputs to the video decoder 110.

For example, the switch 109 continuously outputs the packet of the Base view video and the packet of the Dependent view video set on the same time, as mention that the packet of the Base view video set on a certain time is output, and right after that, the packet of the Dependent view video set on the same time is output.

During encoding the packet accommodating the data of a picture of the Base view video and the packet accommodating the data of a picture of the Dependent view video corresponding thereto are set with the same time information secured with synchronization of a program clock reference (PCR). Even when each of the Base view video stream and the Dependent view video stream is included in a different TS, the packet accommodating a corresponding picture is set with the same time information.

The time information is a decoding time stamp (DTS) and a presentation time stamp (PTS) and set in each packetized elementary stream (PES) packet.

In other words, a picture of the Base view video and a picture of Dependent view video located on the same time when pictures of each stream are arranged in an encoding or decoding order are corresponding pictures. A PES packet accommodating the data of the picture of the Base view video and a PES packet accommodating the data of the picture of the Dependent view video corresponding to the picture in the decoding order are set with the same DTS.

In addition, the picture of the Base view video and the picture of the Dependent view video located on the same time when pictures of each stream are arranged in a display order are also corresponding pictures. A PES packet accommodating the data of a picture of the Base view video and a PES packet accommodating the data of the picture of the Dependent view video corresponding to the picture in the display order are set with the same PTS.

When the GOP structure of the Base view video stream and the GOP structure of the Dependent view video stream are the same structure to be described later, the corresponding pictures in the decoding order become the corresponding pictures in the display order.

When the transmission of a packet is performed serially, a DTS₁ of the packet read from the VSB₁ of the B video buffer 106 at a certain timing and a DTS₂ of the packet read from the VSB₂ of the D video buffer 108 at a timing right after that indicates the same time as shown in FIG. 22.

The switch 109 outputs the packet of the Base view video read from the VSB₁ of the B video buffer 106 or the packet of the Dependent view video read from the VSB₂ of the D video buffer 108 to the video decoder 110.

The video decoder 110 sequentially decodes the packet supplied from the switch 109 and prompts the DPB 151 to store the data of the picture of the Base view video or the data of the picture of the Dependent view video obtained by the decoding.

The data of the decoded picture stored in the DPB 151 are read by a switch 111 at a predetermined timing. In addition, the data of the decoded picture stored in the DPB 151 is used for predicting other pictures by the video decoder 110.

When the transmission of the data is performed serially, the PTS of the data of the picture of the Base view video output at a certain timing and the PTS of the data of the picture of the Dependent view video output right after that indicate the same time.

There is a case where the Base view video stream and the Dependent view video stream are multiplexed in one TS as described above with reference to FIG. 5, and there is a case where each of the streams is included in a different TS as described above with reference to FIG. 7.

By mounting the decoder model shown in FIG. 22, the playback apparatus 1 can respond to even a case where the Base view video stream and the Dependent view video stream are multiplexed in one TS and a case where each of the streams is included in a different TS.

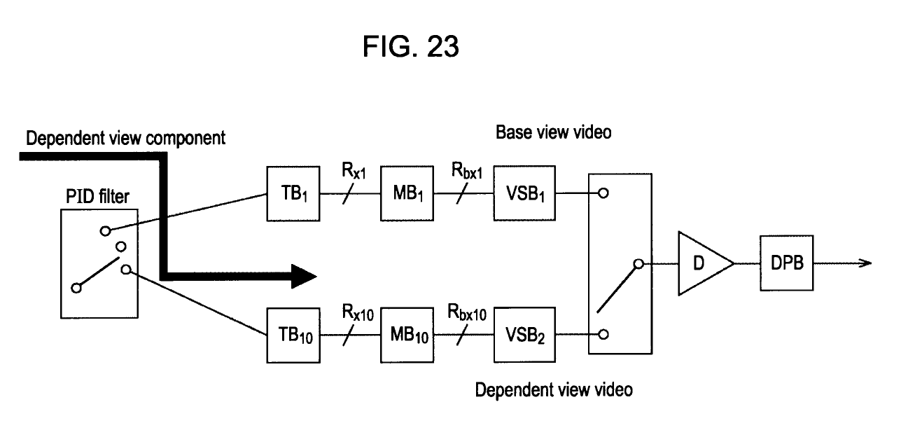

For example, when it is assumed that only one TS is supplied as shown in FIG. 23, the playback apparatus 1 is not able to respond to a case where the Base view video stream and the Dependent view video stream are included in different TSs or the like.

In addition, according to the decoder model shown in FIG. 22, since the DTSs are the same, packets can be supplied to the video decoder 110 at a correct timing even when the Base view video stream and the Dependent view video stream are included in different TSs.

It may be possible that a decoder for the Base view video and a decoder for the Dependent view video are provided in parallel with each other. In this case, packets of the same time are supplied to the decoder for the Base view video and the decoder for the Dependent view video at the same timing.

### Second Example

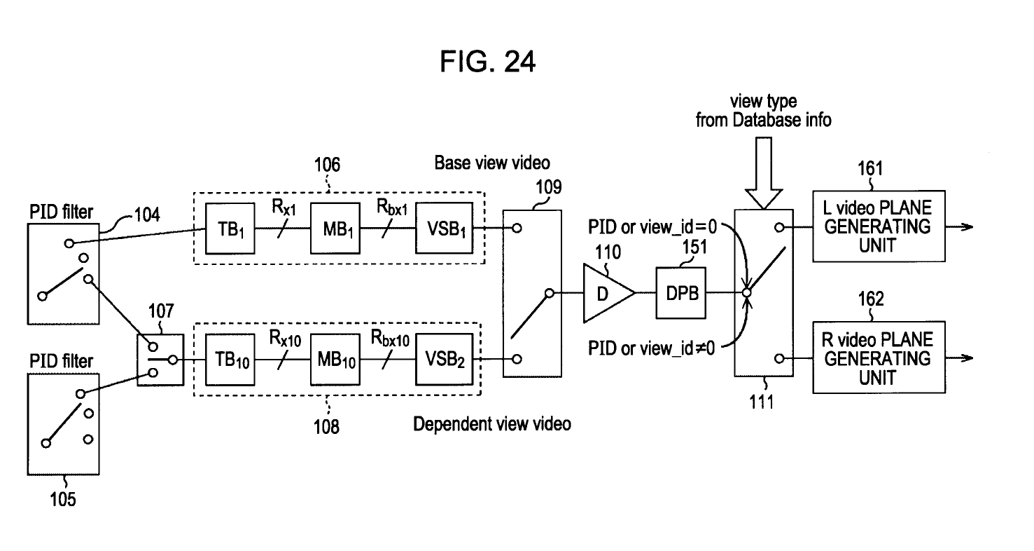

FIG. 24 is a diagram illustrating another composition for performing a process of a video stream.

FIG. 24 shows the switch 111, an L video plane generating unit 161, and an R video plan generating unit 162 in addition to the composition in FIG. 22. In addition, the PID filter 105 is shown in the former part of the switch 107. Repetitive description will be appropriately omitted.

The L video plane generating unit 161 generates a plane of the L view video, and is provided instead of the B video plane generating unit 112 shown in FIG. 21.

The R video plane generating unit 162 generates a plane of the R view video, and is provided instead of the D video plane generating unit 113 shown in FIG. 21.

In this example, the switch 111 is necessary to identify and output the video data of the L view and the video data of the R view.

In other words, the switch 111 is necessary to identify which video data between of the L view and R view the data obtained by decoding the packet of the Base view video is.

In addition, the switch 111 is necessary to identify which video data between of the L view and R view the data obtained by decoding the packet of the Dependent view video is.

For the determination of the L view and the R view, the view_type described above with reference to FIG. 12 and FIG. 14 is used. For example, the controller 51 outputs the view_type described in the PlayList file to the switch 111.

When the value of the view_type is 0, the switch 111 outputs the data obtained by decoding the packet of the Base view video identified as PID=0 among the data stored in the DPB 151 to the L video plane generating unit 161. As described above, the 0 as the value of the view_type indicates that the Base view video stream is a stream of the L view.

In this case, the switch 111 outputs the data obtained by decoding the packet of the Dependent view video identified as other PID than 0 to the R video plane generating unit 162.

On the other hand, when the value of the view_type is 1, the switch 111 outputs the data obtained by decoding the packet of the Base view video identified as PID=0 among the data stored in the DPB 151 to the R video plane generating unit 162. The 1 as the value of the view_type indicates that the Base view video stream is a stream of the R view.

In this case, the switch 111 outputs the data obtained by decoding the packet of the Dependent view video identified other PID than 0 to the L video plane generating unit 161.

The L video plane generating unit 161 generates a plane of the L view video based on the data supplied from the switch 111 and outputs to the synthesizing unit 130.

The R video plane generating unit 162 generates a plane of the R view video based on the data supplied from the switch 111 and outputs to the synthesizing unit 130.

In the elementary stream of the Base view video and the Dependent view video encoded with H.264 AVC/MVC, there is no information (field) indicating whether it is an L view or an R view.

Therefore, by setting the view_type in the PlayList file, a recording device enables the playback apparatus 1 to identify which of a stream between of the L view and the R view each of the Base view video stream and the Dependent view video stream is.

The playback apparatus 1 identifies which of a stream between of the L view and the R view each of the Base view video stream and the Dependent view video stream is, and can redirect the output according to the identification result.

When each of the L view and the R view is prepared for planes of the IG and PG, the L view and the R view of video streams can be distinguished, and thereby the playback apparatus 1 can easily perform the synthesization of L views and the synthesization of R views.

As described above, when video signal are output via an HDMI cable, it is necessary to perform the output after distinguishing a signal of the L view and a signal of the R view, but the playback apparatus 1 can respond to the requirement.

It may be possible that the identification of the data obtained by decoding the packet of the Base view video stored in the DPB 151 and the data obtained by decoding the packet of the Dependent view video is performed based on a view_id, not on a PID.

During encoding with H.264 AVC/MVC, Access Unit forming a stream of the encoding result is wet with the view_id. With the view_id, it is possible to identify which unit of view component each Access Unit is.

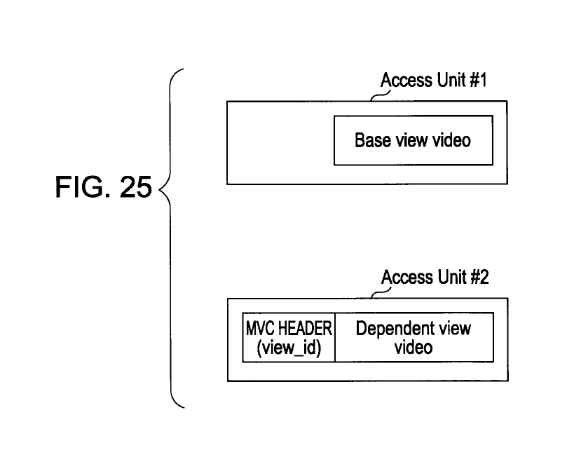

FIG. 25 is a diagram illustrating an example of Access Unit.

An Access Unit #1 of FIG. 25 is a unit including the data of the Base view video. An Access Unit #2 is a unit including the data of the Dependent view video. The Access Unit is a unit organized with, for example, one piece of picture so as to be accessible in a picture unit.

By performing encoding with H.264 AVC/MVC, each picture of the Base view video and the Dependent view video is accommodated in such an Access Unit. During the encoding with H.264 AVC/MVC, each of view components is added with an MVC header as shown in the Access Unit #2. The MVC header includes the view_id.

In case of the example in FIG. 25, it is possible to identify the fact that the view component accommodated in the Access Unit is the Dependent view video from the view_id in the Access Unit #2.

On the other hand, as shown in FIG. 25, the MVC header is not added to the Base view video which is a view component accommodated in the Access Unit #1.

As described above, the Base view video stream is data used also in 2D playback. Therefore, in order to secure compatibility, the MVC header is not added to the Base view video during encoding. Or, the MVC header added once is removed. Encoding by a recording device will be described later.

In the playback apparatus 1, the view_id is 0 for the view component to which the MVC header is not added, and it is defined (set) so that the view component is identified as the Base view video. In the Dependent view video, a value other than 0 is set as the view_id during encoding.

Accordingly, the playback apparatus 1 can identify the Base view video based on the view_id recognized as 0, and can identify the Dependent view video based on the view_id other than 0 that is actually set.

In the switch 111 of FIG. 24, it may be possible that the identification of the data obtained by decoding the packet of the Base view video and the data obtained by decoding the packet of the Dependent view video is performed based on such view_id.

### Third Example

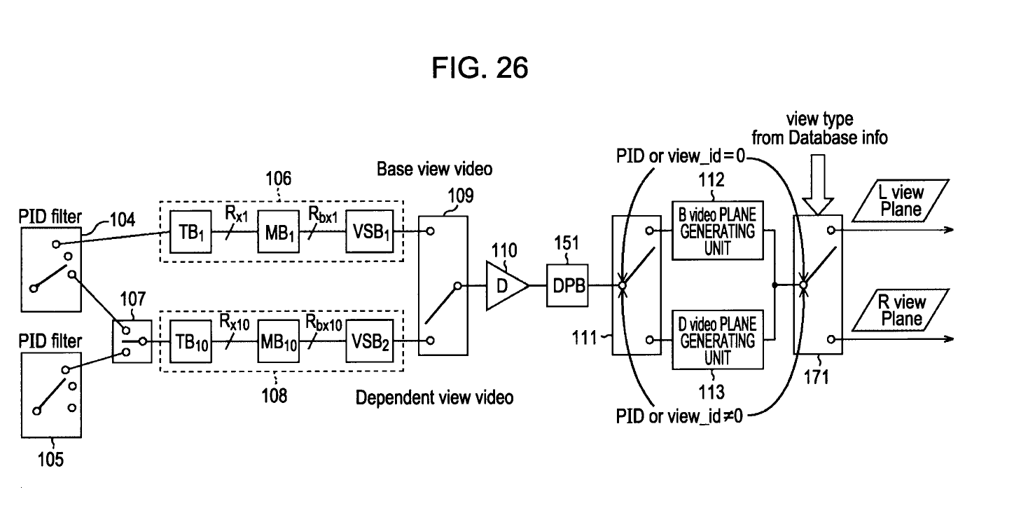

FIG. 26 is a diagram illustrating still another composition for performing a process of a video stream.

In the example of FIG. 26, B video plane generating unit 112 is provided instead of the L video plane generating unit 161 of FIG. 24, and the D video plane generating unit 113 is provided instead of the R video plane generating unit 162. In the latter part of the B video plane generating unit 112 and the D video plane generating unit 113, a switch 171 is provided. Also in the composition shown in FIG. 26, the output of the data is redirected based on the view_type.

The switch 111 outputs the data obtained by decoding the packet of the Base view video among the data stored in the DPB 151 to the B video plane generating unit 112. In addition, the switch 111 outputs the data obtained by decoding the packet of the Dependent view video to the D video plane generating unit 113.

The data obtained by decoding the packet of the Base view video and the data obtained by decoding the packet of the Dependent view video are identified based on the PID or view_id as described above.

The B video plane generating unit 112 generates and outputs the plane of the Base view video based on the data supplied from the switch 111.

The D video plane generating unit 113 generates the plane of the Dependent view video based on the data supplied from the switch 111 and outputs.

The view_type described in the PlayList file is supplied to the switch 171 from the controller 51.

When the value of the view_type is 0, the switch 171 outputs the plane of the Base view video supplied from the B video plane generating unit 112 to the synthesizing unit 130 as a plane of the L view video. The 0 as the value of the view_type indicates that the Base view video stream is a stream of the L view.

In addition, in this case, the switch 171 outputs the plane of the Dependent view video supplied from the D video plane generating unit 113 to the synthesizing unit 130 as a plane of the R view video.

On the other hand, when the value of the view_type is 1, the switch 171 outputs the plane of the Dependent view video supplied from the D video plane generating unit 113 to the synthesizing unit 130 as a plane of the L view video. The 1 as the value of the view_type indicates that the Base view video stream is a stream of the R view.

In addition, in this case, the switch 171 outputs the plane of the Base view video supplied from the B video plane generating unit 112 to the synthesizing unit 130 as a plane of the R view video.

With the composition in FIG. 26, the playback apparatus 1 can identify the L view and the R view and redirect the output according to the identification result.

### First Example of Plane Synthesizing Model

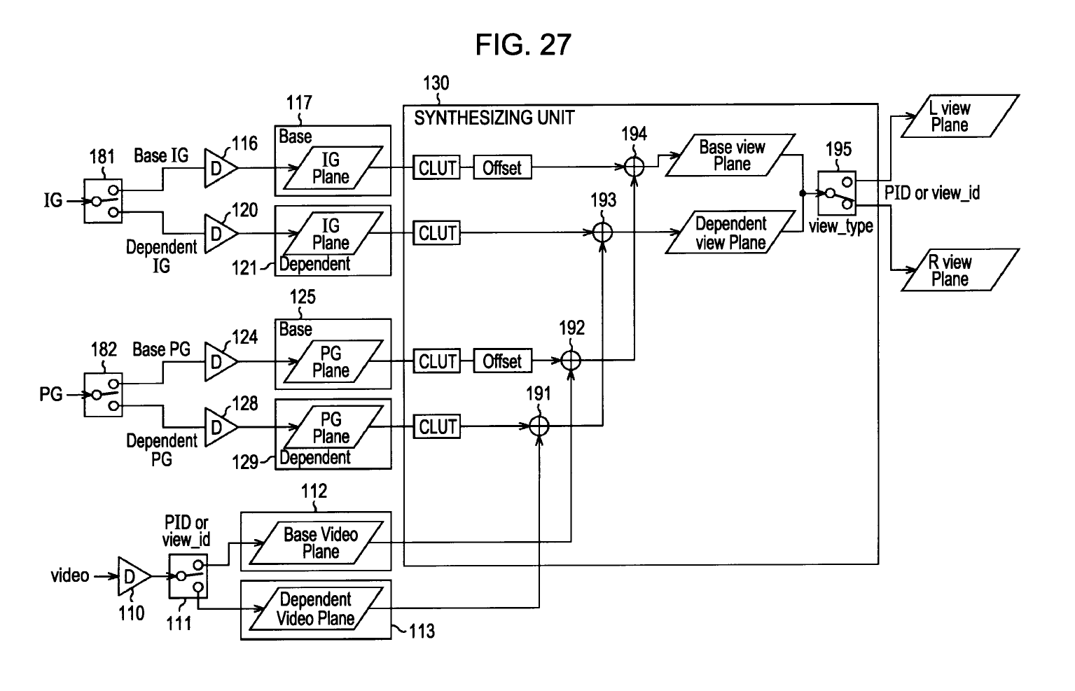

FIG. 27 is a diagram illustrating the composition of the synthesizing unit 130 and the previous stage from the composition shown in FIG. 21.

Also in FIG. 27, the same constituent components as those in FIG. 21 are given with the same reference numerals.

A packet forming the IG stream included in the Main TS or the Sub TS is input to a switch 181. A packet of the Base view and a packet of the Dependent view are included in the packet forming the IG stream input to the switch 181.

A packet forming the PG stream included in the Main TS or the Sub TS is input to a switch 182. A packet of the Base view and a packet of the Dependent view are included in the packet forming the PG stream input to the switch 182.

As described above with reference to FIG. 5, streams of the Base view and Dependent view are prepared for the IG and PG to perform 3D display.

The IG of the Base view is synthesized with the Base view video and displayed, and the IG of the Dependent view is synthesized with the Dependent view video and displayed, and thereby a user can three-dimensionally see not only a video but also a button, an icon or the like.

In addition, the PG of the Base view is synthesized with the Base view video and displayed, and the PG of the Dependent view is synthesized with the Dependent view video and displayed, and thereby the user can three-dimensionally see not only a video but also subtitle text or the like.

The switch 181 outputs the packet forming the Base IG stream to the B IG decoder 116 and outputs the packet forming the Dependent IG stream to the D IG decoder 120. The switch 181 has functions as the switch 114 and the switch 118 of FIG. 21. In FIG. 27, each buffer is not shown.

The B IG decoder 116 decodes the packet forming the Base IG stream supplied from the switch 181 and outputs the data obtained by the decoding to the B IG plane generating unit 117.

The B IG plane generating unit 117 generates the plane of the Base IG based on the data supplied from the B IG decoder 116 and outputs the plane to the synthesizing unit 130.

The D IG decoder 120 decodes the packet forming the Dependent IG stream supplied from the switch 181 and outputs the data obtained by the decoding to the D IG plane generating unit 121. It may be possible that the Base IG stream and the Dependent IG stream are decoded by one decoder.

The D IG plane generating unit 121 generates the plane of the Dependent IG based on the data supplied from the D IG decoder 120 and outputs the plane to the synthesizing unit 130.

A switch 182 outputs the packet forming the Base PG stream to the B PG decoder 124, and outputs the packet forming the Dependent PG stream to the D PG decoder 128. The switch 182 has functions as the switch 122 and the switch 126 of FIG. 21.

The B PG decoder 124 decodes the packet forming the Base PG stream supplied from the switch 182 and outputs the data obtained by the decoding to the B PG plane generating unit 125.

The B PG plane generating unit 125 generates the plane of the Base PG based on the data supplied from the B PG decoder 124 and outputs the plane to the synthesizing unit 130.

The D PG decoder 128 decodes the packet forming the Dependent PG stream supplied from the switch 182 and outputs the data obtained by the decoding to the D PG plane generating unit 129. It may be possible that the Base PG stream and the Dependent PG stream are decoded by one decoder.

The D PG plane generating unit 129 generates the plane of the Dependent PG based on the data supplied from the D PG decoder 128 and outputs the plane to the synthesizing unit 130.

The video decoder 110 sequentially decodes packets supplied from the switch 109 (FIG. 22 and the like) and outputs the data of the Base view video or the data of Dependent view video obtained by the decoding to the switch 111.

The switch 111 outputs the data obtained by decoding the packet of the Base view video to the B video plane generating unit 112 and outputs the data obtained by decoding the packet of the Dependent view video to the D video plane generating unit 113.

The B video plane generating unit 112 generates and outputs the plane of the Base view video based on the data supplied from the switch 111.

The D video plane generating unit 113 generates and outputs the plane of the Dependent view video based on the data supplied from the switch 111.

The synthesizing unit 130 includes calculating units 191 to 194 and a switch 195.

The calculating unit 191 performs synthesization by overlapping the plane of the Dependent PG supplied from the D PG plane generating unit 129 with the plane of the Dependent view video supplied from the D video plane generating unit 113, and outputs the synthesization result to the calculating unit 193. The plane of the Dependent PG supplied from the D PG plane generating unit 129 to the calculating unit 191 is subjected to a color information conversion process (color look-up table (CLUT) process).

The calculating unit 192 performs synthesization by overlapping the plane of the Base PG supplied from the B PG plane generating unit 125 with the plane of the Base view video supplied from the B video plane generating unit 112, and outputs the synthesization result to the calculating unit 194. The plane of the Base PG supplied from the B PG plane generating unit 125 to the calculating unit 192 is subjected to the color information conversion process or a correction process using an offset value.

The calculating unit 193 performs synthesization by overlapping the plane of the Dependent IG supplied from the D IG plane generating unit 121 on the synthesization result from the calculating unit 191 and outputs the synthesization result as the plane of the Dependent view. The plane of the Dependent IG supplied from the D IG plane generating unit 121 to the calculating unit 193 is subjected to the color information conversion process.

The calculating unit 194 performs synthesization by overlapping the plane of Base IG supplied from the B IG plane generating unit 117 on the synthesization result from the calculating unit 192 and outputs the synthesization result as the plane of the Base view. The plane of the Base IG supplied from the D IG plane generating unit 121 to the calculating unit 194 is subjected to the color information conversion process and the correction process using an offset value.

An image displayed based on the plane of Base view and the plane of the Dependent view generated as above has a form in which a button or an icon is shown at the front, subtitle text is shown below that (in depth direction), and a video is shown below that.

The switch 195 outputs the plane of the Base view as the plane of the L view, and outputs the plane of the Dependent view as the plane of the R view when the value of the view_type is 0. The switch 195 is supplied with the view_type from the controller 51.

In addition, the switch 195 outputs the plane of the Base view as the plane of the R view and the plane of the Dependent view as the plane of the L view when the value of the view_type is 1. Which plane among the supplied planes is the plane of Base view or the plane of Dependent view will be determined based on the PID or the view_id.

As such, the playback apparatus 1 performs the synthesization of planes of the Base view, planes of the Dependent view and each plane of video, IG, and PG.

In the stage where the synthesization of all the planes of the video, IG, and PG is finished, whether the result of synthesizing the planes of the Base view is the L view or the R view is determined based on the view_type, and the plane of the R view and the plane of the L view are output respectively.

In addition, in the stage where the synthesization of all the planes of the video, IG, and PG is finished, whether the result of synthesizing the plane of the Dependent view is the L view or the R view is determined based on the view_type, and the plane of the R view and the plane of the L view are output respectively.

### Second Example

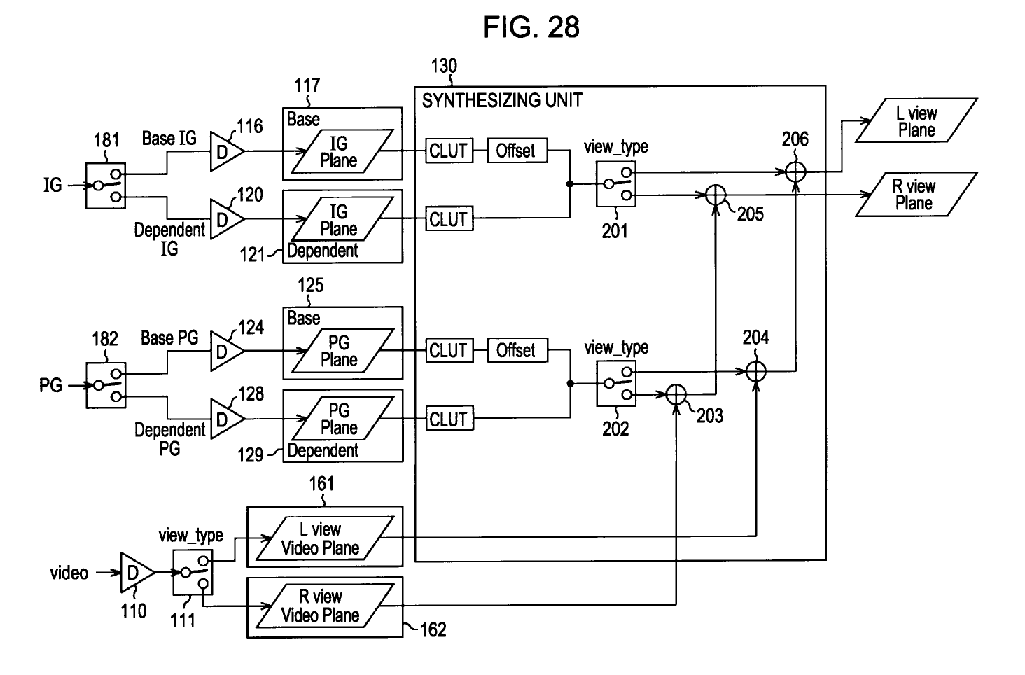

FIG. 28 is a diagram illustrating the composition of the synthesizing unit 130 and the previous stage.

In the composition shown in FIG. 28, the same constituent components as those shown in FIG. 27 are given with the same reference numerals. In FIG. 28, the composition of the synthesizing unit 130 is different from that of FIG. 27. In addition, the operation of the switch 111 is different from that of the switch 111 of FIG. 27. An L video plane generating unit 161 is provided instead of the B video plane generating unit 112, and an R video plane generating unit 162 is provided instead of the d video plane generating unit 113. Repetitive description is omitted.

The value of the same view_type is supplied to the switch 111 and a switch 201 and a switch 202 of the synthesizing unit 130 from the controller 51.

The switch 111 redirects the output of the data obtained by decoding the packet of the Base view video and the data obtained by decoding the packet of the Dependent view video based on the view_type as the switch 111 of FIG. 24 does.

For example, when the value of the view_type is 0, the switch 111 outputs the data obtained by decoding the packet of the Base view video to the L video plane generating unit 161. In this case, the switch 111 outputs the data obtained by decoding the packet of the Dependent view video to the R video plane generating unit 162.

On the other hand, when the value of the view_type is 1, the switch 111 outputs the data obtained by decoding the packet of the Base view video to the R video plane generating unit 162. In this case, the switch 111 outputs the data obtained by decoding the packet of the Dependent view video to the L video plane generating unit 161.

The L video plane generating unit 161 generates the plane of the L view video based on the data supplied from the switch 111 and outputs the plane to the synthesizing unit 130.

The R video plane generating unit 162 generates the plane of the R view video based pm the data supplied from the switch 111 and outputs the plane to the synthesizing unit 130.

The synthesizing unit 130 includes the switch 201, the switch 202, and calculating units 203 to 206.

The switch 201 redirects the output of the plane of the Base IG supplied from the B IG plane generating unit 117 and the plane of the Dependent IG supplied from the D IG plane generating unit 121 based on the view_type.

For example, when the value of the view_type is 0, the switch 201 outputs the plane of the Base IG supplied from the B IG plane generating unit 117 to the calculating unit 206 as a plane of the L view. In this case, the switch 201 outputs the plane of the Dependent IG supplied from the D IG plane generating unit 121 to the calculating unit 205 as a plane of the R view.

On the other hand, when the value of the view_type is 1, the switch 201 outputs the plane of the Dependent IG supplied from the D IG plane generating unit 121 to the calculating unit 206 as a plane of the L view. In this case, the switch 201 outputs the plane of the Base IG supplied from the B IG plane generating unit 117 to the calculating unit 205 as a plane of the R view.

The switch 202 redirects the output of the plane of the Base PG supplied from the B PG plane generating unit 125 and the plane of the Dependent PG supplied from the D PG plane generating unit 129 based on the view_type.

For example, when the value of the view_type is 0, the switch 202 outputs the plane of the Base PG supplied from the B PG plane generating unit 125 to the calculating unit 204 as a plane of the L view. In this case, the switch 202 outputs the plane of the Dependent PG supplied from the D PG plane generating unit 129 to the calculating unit 203 as a plane of the R view.

On the other hand, when the value of the view_type is 1, the switch 202 outputs the plane of the Dependent PG supplied from the D PG plane generating unit 129 to the calculating unit 204 as a plane of the L view. In this case, the switch 202 outputs the plane of the Base PG supplied from the B PG plane generating unit 125 to the calculating unit 203 as a plane of the R view.

The calculating unit 203 performs synthesization by overlapping the plane of the PG of the R view supplied from the switch 202 on the plane of the R view video supplied from the R video plane generating unit 162, and outputs the synthesization result to the calculating unit 205.

The calculating unit 204 performs synthesization by overlapping the plane of the PG of the L view supplied from the switch 202 on the plane of the L view video supplied from the L video plane generating unit 161, and outputs the synthesization result to the calculating unit 206.

The calculating unit 205 performs synthesization by overlapping the plane of the IG of the R view supplied from the switch 201 on the plane of the synthesization result from the calculating unit 203, and outputs the synthesization result as a plane of the R view.

The calculating unit 206 performs synthesization by overlapping the plane of the IG of the L view supplied from the switch 201 on the plane of the synthesization result from the calculating unit 204, and outputs the synthesization result as a plane of the L view.

As such, in the playback apparatus 1, it is determined that which of a plane is the L view or the R view in the plane of the Base view and the plane of the Dependent view of each video, IG, and PG before the synthesization with other planes.

After the determination is performed, each plane of the video, IG and PG is synthesized so that the planes of the L view and the planes of the R view are synthesized.

### Example of Composition of Recording Device

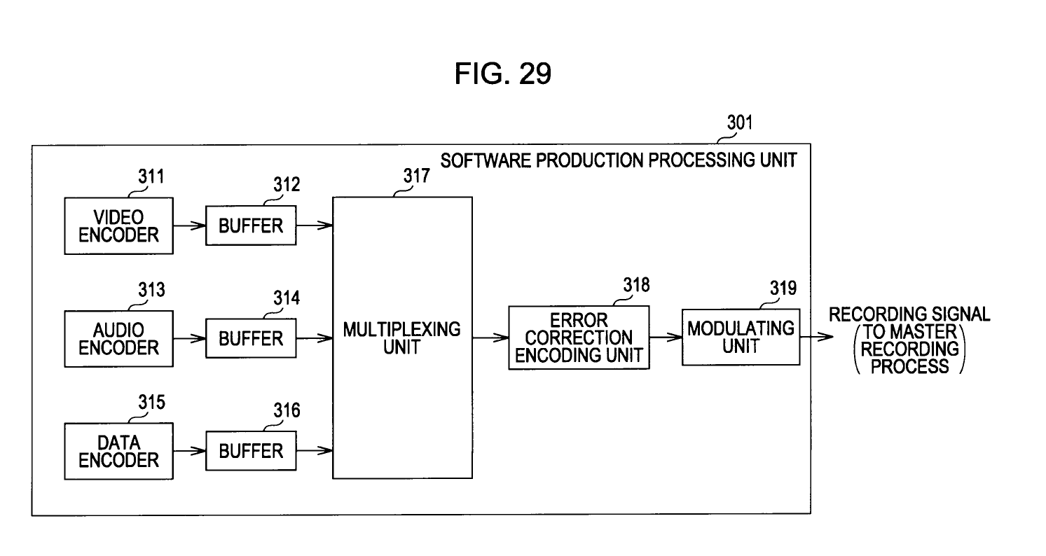

FIG. 29 is a block diagram illustrating an example of the composition of a software production processing unit 301.

A video encoder 311 has the same composition as the MVC encoder 11 of FIG. 3. The video encoder 311 generates a Base view video stream and a Dependent view video stream by encoding a plurality of pieces of video data with the H.264 AVC/MVC, and outputs the streams to a buffer 312.

For example, the video encoder 311 sets a DTS and PTS based on the same PCR during encoding. In other words, the video encoder 311 sets the same DTS to a PES packet accommodating picture data of a certain Base view video and a PES packet accommodating picture data of Dependent view video corresponding to the above picture in a decoding order.

In addition, the video encoder 311 sets the same PTS to a PES packet accommodating picture data of a certain Base view video and a PES packet accommodating picture data of Dependent view video corresponding to the above picture in a display order.

The video encoder 311 sets the same information to each of 1 picture of the Base view video and a picture of the Base view video corresponding to each other in the decoding order, as auxiliary information relating to the decoding to be described later.

Furthermore, the video encoder 311 sets the same value to each of a picture of the Base view video and a picture of the Base view video corresponding to each other in the display order, as a value of POC indicating an output order of pictures to be described later.

In addition, the video encoder 311 performs encoding so that the structure of the GOP of the Base view video stream corresponds with the structure of the GOP of the Dependent view video stream to be described later.

An audio encoder 313 encodes an input audio stream and outputs obtained data to a buffer 314. To the audio encoder 313, an audio stream recorded on a disc is input together with streams of a Base view video and a Dependent view video.

A data encoder 315 encodes various kinds of data such as a PlayList file described above in addition to data of a video and an audio, and outputs data obtained by the encoding to a buffer 316.

The data encoder 315 sets the view_type indicating whether the Base view video stream is a stream of the L view or a stream of the R view to a PlayList file according to the encoding by the video encoder 311. It may possible to set information indicating whether the Dependent view video stream is a stream of the L view or a stream of the R view, not to set the type of the Base view video stream.

In addition, the data encoder 315 sets an EP_map to be described later to a Clip Information file of the Base view video stream and a Clip Information file of the Dependent view video stream. A picture of the Base view video stream set in the EP_map as a decoding starting point corresponds to a picture of the Dependent view video stream.

A multiplexing unit 317 multiplexes video data and audio data stored in each of buffers and data other than streams with a synchronizing signal and outputs the data to an error correction encoding unit 318.

The error correction encoding unit 318 adds codes for error correction to the data multiplexed by the multiplexing unit 317.

A modulating unit 319 performs modulation to the data supplied from the error correction encoding unit 318 and outputs the data. The output of the modulating unit 319 becomes software to be recorded on the optical disc 2 which can be played back in the playback apparatus 1.

The software production processing unit 301 having such a composition is provided in a recording device.

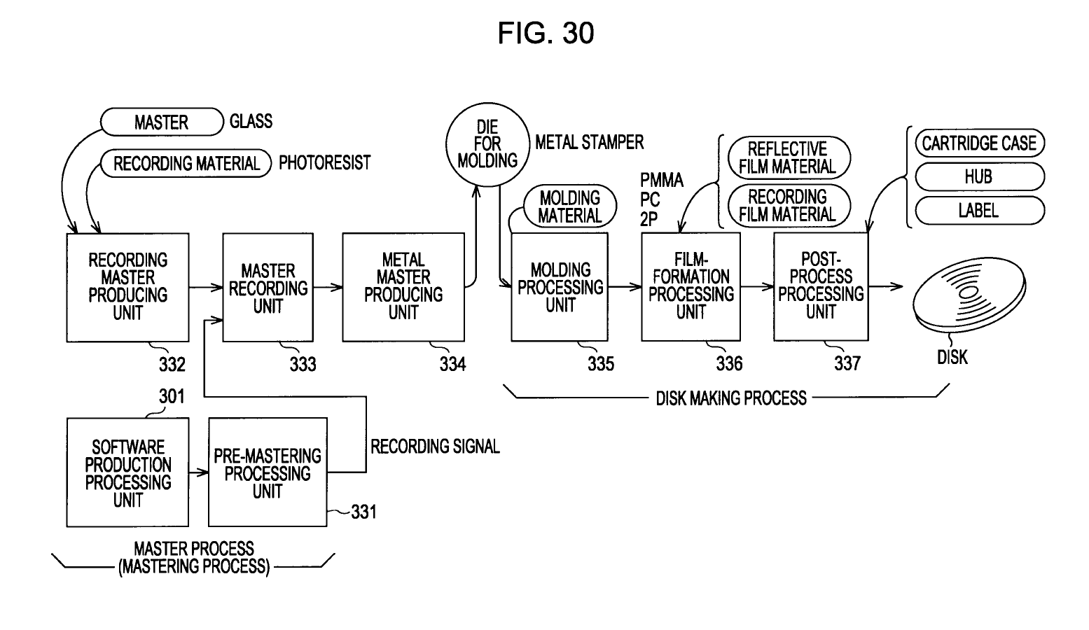

FIG. 30 is a diagram illustrating an example of a composition including the software production processing unit 301.

There is a case where part of the composition shown in FIG. 30 is provided in a recording device.

A recording signal generated by the software production processing unit 301 is subjected to a mastering process in a pre-mastering processing unit 331, and thereby a signal of a format to be recorded on the optical disc 2 is generated. The generated signal is supplied to a master recording unit 333.

In a recording master producing unit 332, a master formed of glass or the like is prepared, and a recording material including a photoresist or the like is coated thereon. Accordingly, a recording master is produced.

In the master recording unit 333, a laser beam is modulated in response to the recording signal supplied from the pre-mastering processing unit 331, and irradiated on the photoresist on the master. Accordingly, the photoresist on the master is exposed in response to the recording signal. After that, the master is developed, and pits on the master are made to appear.

In a metal master producing unit 334, an electro-casing process is performed on the master, and a metal master where pits on the glass master are transferred is produced. A metal stamper is further produced from the metal master and the stamper becomes a die for molding.

In a molding processing unit 335, a material such as PMMA (acryl), PC (polycarbonate) or the like is poured into the die for molding by injection or the like, and fixation is performed. Or, after 2P (ultraviolet-curable resin) or the like is coated on the metal stamper, ultraviolet is irradiated to perform curing. Accordingly, pits on the metal stamper can be transferred onto a replica formed of a resin.

In a film-formation processing unit 336, a reflective film is formed on the replica by deposition, sputtering, or the like. Or, the reflective film is formed on the replica by spin-coating.

In a post-processing unit 337, a processing of inner and outer diameter is performed for the disc, and a necessary treatment such as laminating two discs or the like is performed. Furthermore, after a label is stuck or a hub is attached, the disc is inserted in a cartridge. In that way, the optical disc 2 is completed which can be played back in the playback apparatus 1 and data are recorded thereon.

### Second Embodiment

### Operation of H.264 AVC/MVC Profile Video Stream 1

In the BD-ROM standard as a standard of the optical disc 2, the employment of H.264 AVC/MVC Profile enables the encoding of 3D video as described above.

In addition, in the BD-ROM standard, the Base view video stream is a stream of an L view video and the Dependent view video stream is a stream of an R view video.

By encoding the Base view video as an H.264 AVC/High Profile video stream, it is possible to play back the optical disc 2 for 3D playback in a player in the past or a player for 2D playback. In other words, it is possible to obtain downwards compatibility.

Specifically, only the Base view video stream can be decoded (played back) even in an H.264 AVC/MVC non-corresponding decoder. In other words, the Base view video stream becomes a stream that can be played back even in an existing 2D BD player at all times.

In addition, by using the Base view video stream in both of 2D playback and 3D playback, it is possible to intend a reduction of burden in authoring. The authoring side can produce a disc for 3D playback for AV streams if a Dependent view video stream is prepared in addition to works performed before.

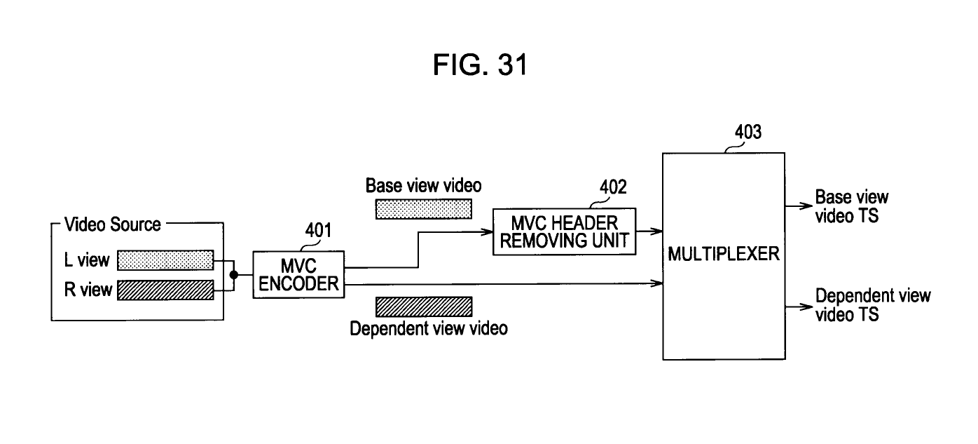

FIG. 31 is a diagram illustrating an example of a composition of a 3D video TS generating unit provided in a recording device.

The 3D video TS generating unit of FIG. 31 includes an MVC encoder 401, an MVC header removing unit 402, and a multiplexer 403. The data of an L view video #1 and the data of an R view video #2 captured as described above with reference to FIG. 2 are input to the MVC encoder 401.

The MVC encoder 401 encodes the data of L view video #1 with the H.264/AVC as the MVC encoder 11 of FIG. 3 does, and AVC video data obtained by the encoding is output as a Base view video stream. In addition, the MVC encoder 401 generates a Dependent view video stream based on the data of the L view video #1 and the data of the R view video #2 and outputs the stream.

The Base view video stream output from the MVC encoder 401 includes an Access Unit accommodating data of each picture of the Base view video. In addition, the Dependent view video stream output from the MVC encoder 401 includes an Access Unit accommodating data of each picture of the Dependent view video.

In the Access Unit forming the Base view video stream and the Access Unit forming the Dependent view video stream, an MVC header in which a view_id is described to identify an accommodated view component is included.

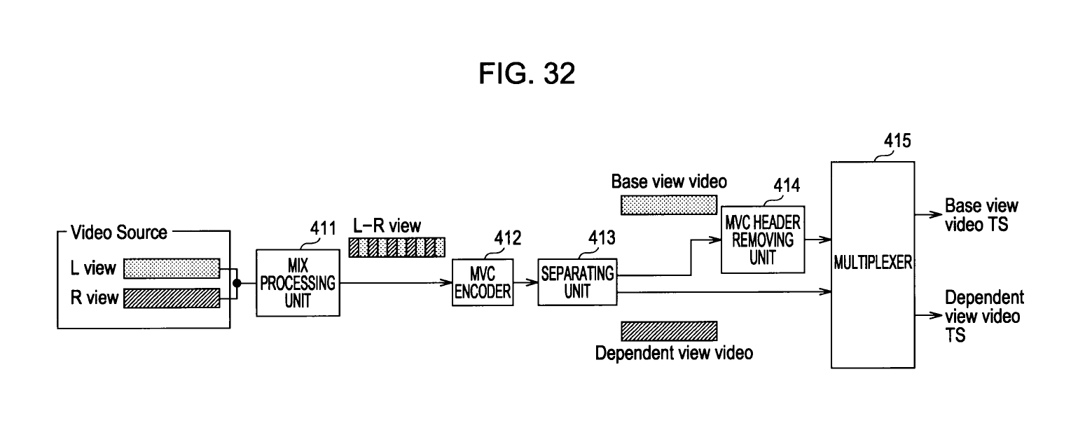

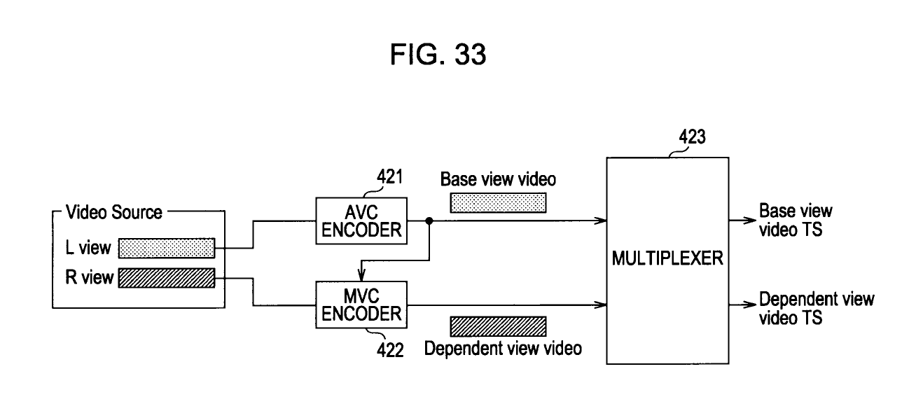

As the value of the view_id described in the MVC header of the Dependent view video, one or more fixed values are used. The same is applied to FIGS. 32 and 33.

In other words, the MVC encoder 401 is an encoder that is different from the MVC encoder 11 of FIG. 3, and generates and outputs each stream of the Base view video and the Dependent view video in a form of adding the MVC header. In the MVC encoder 11 of FIG. 3, only the Dependent view video encoded with the H.264 AVC/MVC is added with the MVC header.

The Base view video stream output from the MVC encoder 401 is supplied to the MVC header removing unit 402 and the Dependent view video stream is supplied to the multiplexer 403.

The MVC header removing unit 402 removes the MVC header included in the Access Unit forming the Base view video stream. The MVC header removing unit 402 outputs the Base view video stream formed of the Access Unit in which the MVC header is removed to the multiplexer 403.

The multiplexer 403 generates and outputs a TS including the Base view video stream supplied from the MVC header removing unit 402 and the Dependent view video stream supplied from the MVC encoder 401. In the example of FIG. 31, the TS including the Base view video stream and the TS including the Dependent view video stream are output respectively, but there is a case there the same TS is multiplexed and output as described above.

As such, depending on the way of mounting, it can be considered that an MVC encoder that inputs an L view video and an R view video and outputs each stream of the Base view video and the Dependent view video with MVC headers.

Furthermore, it is possible to include the whole composition shown in FIG. 31 in the MVC encoder as shown in FIG. 3. The same is applied to the composition shown in FIGS. 32 and 33.

FIG. 32 is a diagram illustrating an example of another composition of a 3D video TS generating unit provided in a recording device.

The 3D video TS generating unit of FIG. 32 includes a mix processing unit 411, an MVC encoder 412, a separating unit 413, an MVC header removing unit 414, and a multiplexer 415. The data of L view video #1 and the data of the R view video #2 are input to the mix processing unit 411.

The mix processing unit 411 arranges each picture of the L view and each picture of the R view in an encoding order. Since encoding is performed for pictures of the Dependent view video with reference to pictures of the Base view video, the arrangement in the encoding results in each picture of L view and each picture of R view arranged alternately.

The mixing processing unit 411 outputs the pictures of the L view and the pictures of the R view arranged in the encoding order to the MVC encoder 412.

The MVC encoder 412 encodes each picture supplied from the mixing processing unit 411 with the H.264 AVC/MVC, and outputs a stream obtained by the encoding to the separating unit 413. The stream output from the MVC encoder 412 is multiplexed with the Base view video stream and the Dependent view video stream.

The Base view video stream included in the stream output from the MVC encoder 412 includes an Access Unit accommodating data of each picture of the Base view video. In addition, the Dependent view video stream included in the stream output from the MVC encoder 412 includes the Access Unit accommodating data of each picture of the Dependent view video.

In the Access Unit forming the Base view video stream and the Access Unit forming the Dependent view video stream includes an MVC header in which a view_id for identifying an accommodated view component is described.

The separating unit 413 separates and outputs the Base view video stream and the Dependent view video stream multiplexed in the stream supplied from the MVC encoder 412. The Base view video stream output from the separating unit 413 is supplied to the MVC header removing unit 414, and the Dependent view video stream is supplied to the multiplexer 415.

The MVC header removing unit 414 removes the MVC header included in the Access Unit forming the Base view video stream supplied from the separating unit 413. The MVC header removing unit 414 outputs the Base view video stream formed of the Access Unit in which the MVC header is removed to the multiplexer 415.

The multiplexer 415 generates and outputs a TS including the Base view video stream supplied from the MVC header removing unit 414 and the Dependent view video stream supplied from the separating unit 413.

FIG. 33 is a diagram illustrating an example of still another composition of a 3D video TS generating unit provided in a recording device.

The 3D video TS generating unit of FIG. 33 includes an AVC encoder 421, an MVC encoder 422, and a multiplexer 423. Data of L view video #1 is input to the AVC encoder 421, and data of R view video #2 is input to the MVC encoder 422.

The AVC encoder 421 encodes the data of the L view video #1 with the H.264/AVC, and outputs an AVC video stream obtained by the encoding to the MVC encoder 422 and the multiplexer 423 as a Base view video stream. An Access Unit forming the Base view video output from the AVC encoder 421 does not include an MVC header.

The MVC encoder 422 decodes the Base view video stream (AVC video stream) supplied from the AVC encoder 421 and generates the data of the L view video #1.

In addition, the MVC encoder 422 generates the Dependent view video based on the data of the L view video #1 obtained by the decoding and the data of the R view video #2, and output the video to the multiplexer 423. The Access Unit forming the Dependent view video stream output from the MVC encoder 422 includes an MVC header.

The multiplexer 423 generates and outputs a TS including the Base view video stream supplied from the AVC encoder 421 and the Dependent view video stream supplied from the MVC encoder 422.

The AVC encoder 421 of FIG. 33 has functions of the H.264/AVC encoder 21 of FIG. 3, and the MVC encoder 422 has functions of the H.264/AVC decoder 22 and the Dependent view video encoder 24 of FIG. 3. In addition, the multiplexer 423 has functions of the multiplexer 25 of FIG. 3.

By providing the 3D video TS generating unit having such a composition in a recording device, it is possible to prohibit encoding of the MVC header for the Access Unit accommodating the data of the Base view video. In addition, it is possible that the Access Unit accommodating the data of the Dependent view video includes an MVC header set with one or more view_ids.

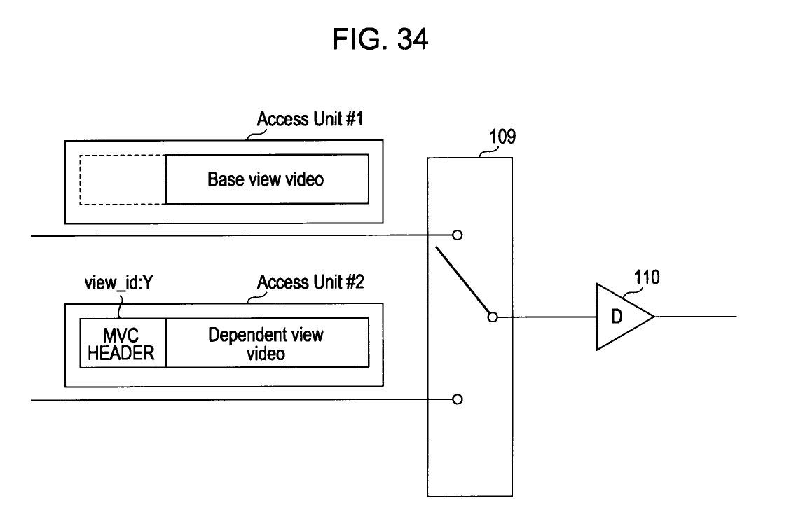

FIG. 34 is a diagram illustrating the composition of the playback apparatus 1 decoding Access Unit.

FIG. 34 shows the switch 109 and the video decoder 110 described with reference to FIG. 22 and the like. Access Unit #1 including data of the Base view video and Access Unit #2 including data of the Dependent view video are read from a buffer and supplied to the switch 109.

Since encoding is performed with reference to the Base view video, it is necessary to decoding the corresponding Base view video first in order to correctly decoding the Dependent view video.

According to the H.264/MVC standard, the decoding side calculates the decoding order of each of Access Unit by using the view_id included in the MVC header. In addition, it is determined that the minimum value is set as the value of the view_id for the Base view video at all times during the encoding. The decoder starts decoding from the Access Unit including the MVC header set with the minimum view_id, and thereby it is possible to decoding the Base view video and the Dependent view video in a correct order.

However, it is prohibited to encoding the MVC header in the Access Unit which is supplied to the video decoder 110 of the playback apparatus 1 and accommodates the Base view video.

Therefore, in the playback apparatus 1, it is defined to recognize the view_id to be 0 for the view component accommodated in the Access Unit not including the MVC header.

Accordingly, the playback apparatus 1 can identify the Base view video based on the view_id recognized as 0, and identify the Dependent view video based on other view_id than 0 that is actually set.

The switch 109 of FIG. 34 outputs the Access Unit #1 recognized that 0 as the minimum value is set as the view_id first to the video decoder 110 and prompts decoding.

In addition, the switch 109 outputs the Access Unit #2 in which Y as a fixed value greater than 0 is set as the view_id to the video decoder 110 after the decoding of the Access Unit #1 is finished, and prompts decoding. A picture of the Dependent view video accommodated in the Access Unit #2 corresponds to a picture of the Base view video accommodated in the Access Unit #1.

As such, by prohibiting the encoding of the MVC header for the Access Unit accommodating the Base view video, the Base view video stream recorded on the optical disc 2 can be a stream that can be played back in a player of the past.

As a condition of the Base view video stream in the BD-ROM 3D standard which is extended from the BD-ROM standard, even when a condition is determined to use the stream that can be played back in a player of the past, it is possible to satisfy the condition.

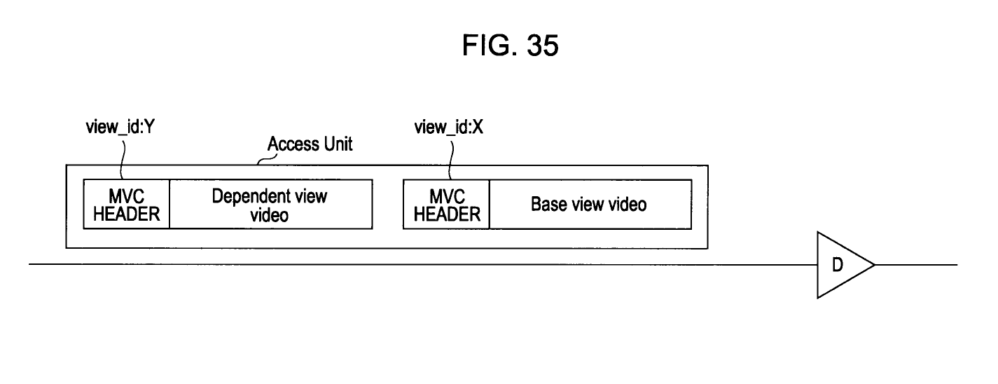

For example, as shown in FIG. 35, when each MVC header is added to the Base view video and the Dependent view video, and decoding is performed first from the Base view video, the Base view video is not able to be played back in the player of the past. The MVC headers are undefined data for the H.264/AVC decoder mounted in the player of the past. When such undefined data are input, the decoder is not able to ignore the data and there is a concern that the process may fail.

Moreover, in FIG. 35, the view_id of the Base view video is X, and the view_id of the Dependent view video is Y, which is greater than X.

In addition, even when the encoding of the MVC header is prohibited, it is defined that the view_id of the Base view video is recognized as 0, and thereby it is possible for the playback apparatus 1 to decode the Base view video first and then decode the Dependent view video. In other words, it is possible for the device to perform decoding in the correct order.

### Operation 2

### Regarding GOP Structure

In the H.264/AVC standard, the Group of Pictures (GOP) structure is not defined in the MPEG-2 video standard.

Therefore, in the BD-ROM standard that deals with the H.264/AVC video stream, the GOP structure of the H.264/AVC video stream is defined, and various functions using the GOP structure of random access or the like are realized.

In the Base view video stream and the Dependent view video stream which are video streams obtained by encoding with the H.264 AVC/MVC, the definition of the GOP structure does not exist as in the H.264/AVC video stream.

The Base view video stream is the H.264/AVC video stream. Therefore, the GOP structure of the Base view video stream has the same structure as the GOP structure of the H.264/AVC video stream defined in the BD-ROM standard.

The GOP structure of the Dependent view video stream is defined to be the same as the GOP structure of the Base view video stream, that is, the GOP structure of the H.264/AVC video stream defined in the BD-ROM standard.

The GOP structure of the H.264/AVC video stream defined in the BD-ROM standard has the following characteristics.

### 1. Characteristics of Stream Structure

### (1) The Structure of Open GOP and Closed GOP

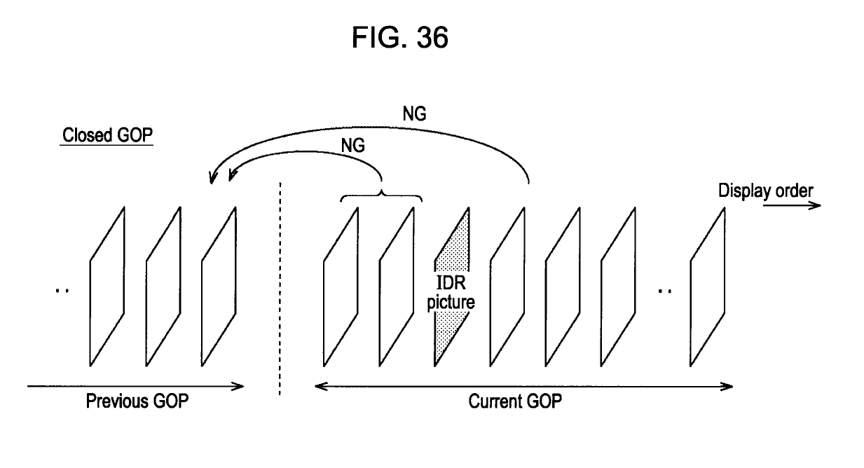

FIG. 36 is a diagram illustrating the structure of a Closed GOP.

Each picture of FIG. 36 is a picture forming an H.264/AVC video stream. The Closed GOP includes instantaneous decoding refresh (IDR) pictures.

An IDR picture is an I-picture, which is decoded first in the GOP including the IDR pictures. When the IDR pictures are decoded, all information relating to the state of a reference picture buffer (DPB 151 of FIG. 22), a frame number that has been managed, and decoding Picture Order count (POC) or the like is reset.

As shown in FIG. 36, in the current GOP which is the Closed GOP, it is prohibited that a picture placed earlier (past) than the IDR picture in the display order among picture of the current GOP refers to a picture of just previous GOP.

In addition, among picture of the current GOP, it is prohibited that a picture placed later (future) than the IDR picture in the display order a picture of the just previous GOP over the IDR picture. In the H.264/AVC, it is allowed that a P-picture placed in the later than the I-picture in the display order refers to a picture placed earlier than the I-picture.

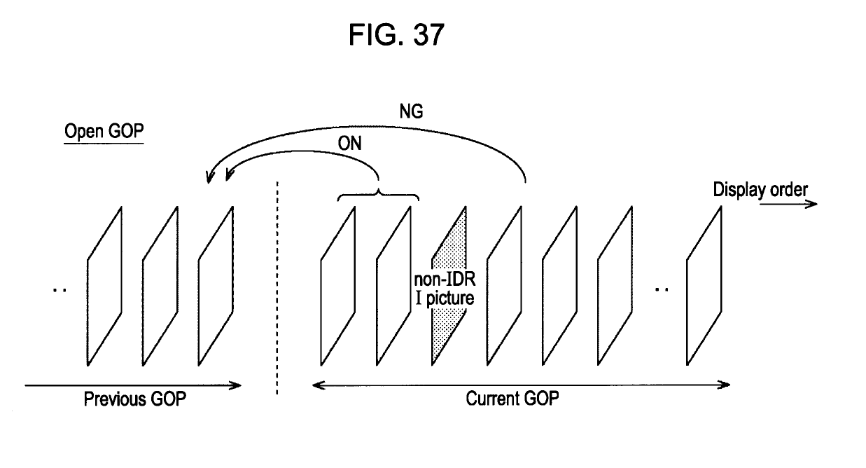

FIG. 37 is a diagram illustrating the structure of an Open GOP.

As shown in FIG. 37, in the current GOP which is an Open GOP, it is allowed that a picture placed in earlier than a non-IDR I-picture (an I-picture which is not an IDR picture) in the display order among picture of the current GOP refers to a picture of the just previous GOP.

In addition, among picture of the current GOP, it is prohibited that a picture placed later than the non-IDR I-picture in the display order refers to a picture of just previous GOP over the non-IDR I-picture.

### (2) In the Access Unit of the Head of the GOP, an SPS and a PPS are Necessarily Encoded.

The sequence parameter set (SPS) is header information of a sequence including information on encoding of the whole sequence. When a certain sequence is decoded, an SPS including identification information of a sequence becomes necessary first. The picture parameter set (PPS) is header information of a picture including information on encoding of the whole picture.

(3) In the Access Unit of the head of the GOP, 30 PPSs can be encoded at the maximum. When a plurality of PPSs is encoded in the head Access Unit, ids of each PPS (pic_parameter_set_id) are not the same.
(4) In the Access Unit of other than the head of the GOP, one PPS can be encoded at the maximum.

### 2. Characteristics of Reference Structure

(1) It is sought that an I-, P-, and B-picture are pictures including only an I-, P-, and B-slice.
(2) It is sought that the B-picture just before a reference picture (I- or P-picture) in the display order is necessarily encoded just after the reference picture in the encoding order.
(3) It is sought that the encoding order and the display order of the reference picture (I- or P-picture) is to be maintained (to be the same).
(4) It is prohibited that the P-picture refers to the B-picture.
(5) It is sought that when a non-reference B-picture (B1) is placed before a non-reference picture (B2) in the encoding order, the B1 comes earlier in the display order.

The non-reference B-picture is a B-picture not referred to by other picture placed later in the encoding order.

(6) The reference B-picture can refer to a reference picture (I- or P-picture) placed just earlier or later in the display order.
(7) The non-reference B-picture can refer to a reference B-picture or a reference picture (I- or P-picture) placed just earlier or later in the display order.
(8) It is sought that the number of consecutive B-pictures is 3 pieces at the maximum.

### 3. Characteristics of Maximum Number of Frames and Fields in GOP.

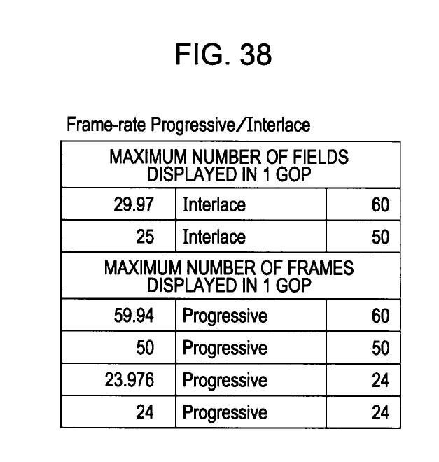

The maximum number of frames and fields in the GOP is regulated according to a frame rate of a video as shown in FIG. 38.

As shown in FIG. 38, for example, when an interlaced display is performed with a frame rate of 29.97 frames/sec, the maximum number of fields which can be displayed with a picture of 1 GOP is 60. In addition, when a progressive display is performed with a frame rate of 59.94, the maximum number of frames that can be displayed with a picture of 1 GOP is 60.

The GOP structure having characteristics as above is also defined as the GOP structure of the Dependent view video stream.

In addition, coincidence between a certain GOP structure of the Base view video stream and the corresponding GOP structure of the Dependent view video stream is regulated as a restriction.

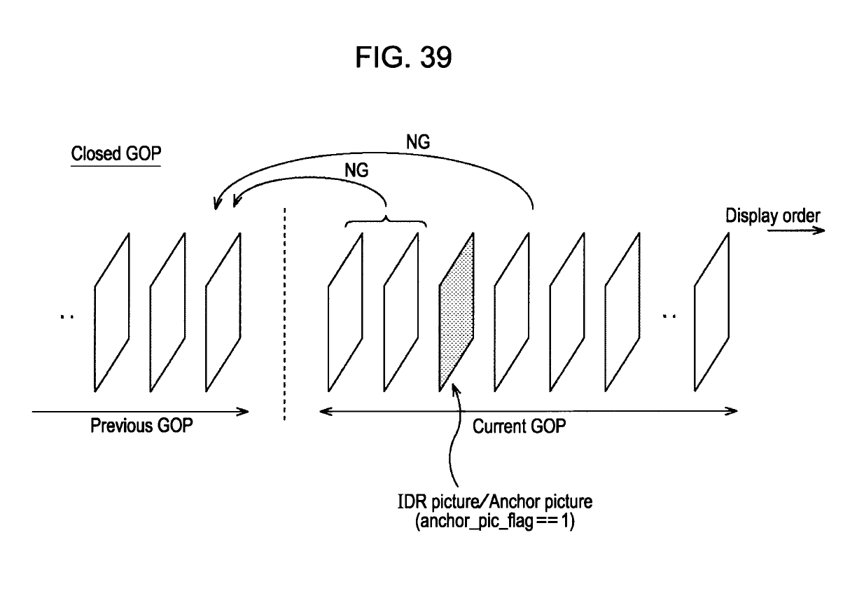

The Closed GOP structure of the Base view video stream or the Dependent view video stream defined as above is shown in FIG. 39.

As shown in FIG. 39, in the current GOP which is a Closed GOP, it is prohibited that a picture placed earlier (past) than an IDR picture or an anchor picture in the display order among picture of the current GOP refers to a picture of just previous GOP. The anchor picture will be described later.

In addition, among picture of the current GOP, it is prohibited that a picture placed later (future) than an IDR picture or an anchor picture in the display order refers to a picture of just previous GOP over the IDR picture or the anchor picture.

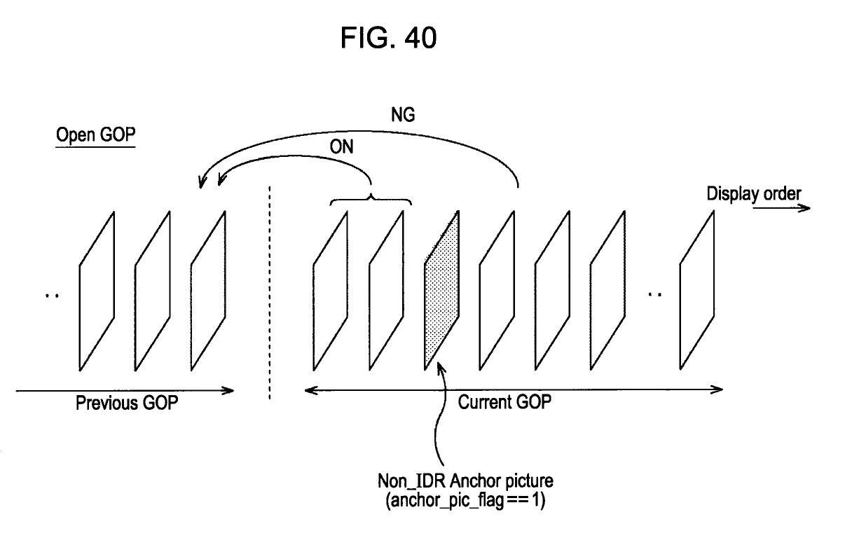

FIG. 40 is a diagram illustrating the structure of an Open GOP of the Base view video stream or the Dependent view video stream.

As shown in FIG. 40, in the current GOP which is an Open GOP, it is allowed that a picture placed earlier than a non-IDR anchor picture (an anchor picture which is not an IDR picture) in the display order among picture of the current GOP refers to a picture of just previous GOP.

In addition, among picture of the current GOP, it is prohibited that a picture placed later than a non-IDR anchor picture in the display order refers to a picture of just previous GOP over the non-IDR anchor picture.

By defining the GOP structure as described above, for example, between a certain GOP of the Base view video stream and the corresponding GOP of the Dependent view video stream, characteristics of the stream structures that they are an Open GOP or a Closed GOP coincide.

In addition, as mentioned that the picture of the Dependent view video corresponding to the non-reference B-picture of the Base view video is necessarily a non-reference B-picture, characteristics of the reference structure of pictures coincide.

Furthermore, between a certain GOP of the Base view video stream and the corresponding GOP of the Dependent view video stream, the number of frames and fields also coincides.

As such, by defining the GOP structure of the Dependent view video stream same as the GOP structure of the Base view video stream, it is possible to bring the same characteristics for the corresponding GOPs between the streams.

In addition, when decoding is performed in the middle of the streams, it is possible to perform the execution without failure. The decoding in the middle of the streams, for example, is performed in case of a trick play or random access.

As mentioned that the number of frames are different, when the structures of corresponding GOPs between streams are different, there is a concern that one stream can be normally played back, but the other steam is not played back. However, this can be preventive.

When decoding is started in the middle of a stream with the structure of corresponding GOPs between streams, there is also another concern that a picture of a Base view video necessary for decoding the Dependent view video is not decoded. In this case, as a result, a picture of the Dependent view video is not able to be decoded and thereby 3D display is not possible. In addition, depending on methods of implementation, there is a possibility that an image of the Base view video is not able to be output, but such failure can be avoided.

### Regarding EP_map

By using a GOP structure of the Base view video stream and the Dependent view video stream, it is possible to set a decoding starting point during random access or trick play in an EP_map. The EP_map is included in a Clip Information file.

There are two restrictions as follows as restrictions of a picture that can be set as a decoding starting point in an EP_map.

1. The point that can be set in the Dependent view video stream is set to be the point of an anchor picture arranged continuously to a SubsetSPS or the point of an IDR picture arranged continuously to a SubsetSPS.

An anchor picture is a picture defined with the H.264 AVC/MVC, and a picture of the Dependent view video stream encoded with reference to views without referring to a time direction.

2. When a picture of the Dependent view video stream is set as a decoding starting point in an EP_map, the corresponding picture of the Base view video stream is set as a decoding starting point in the EP_map.

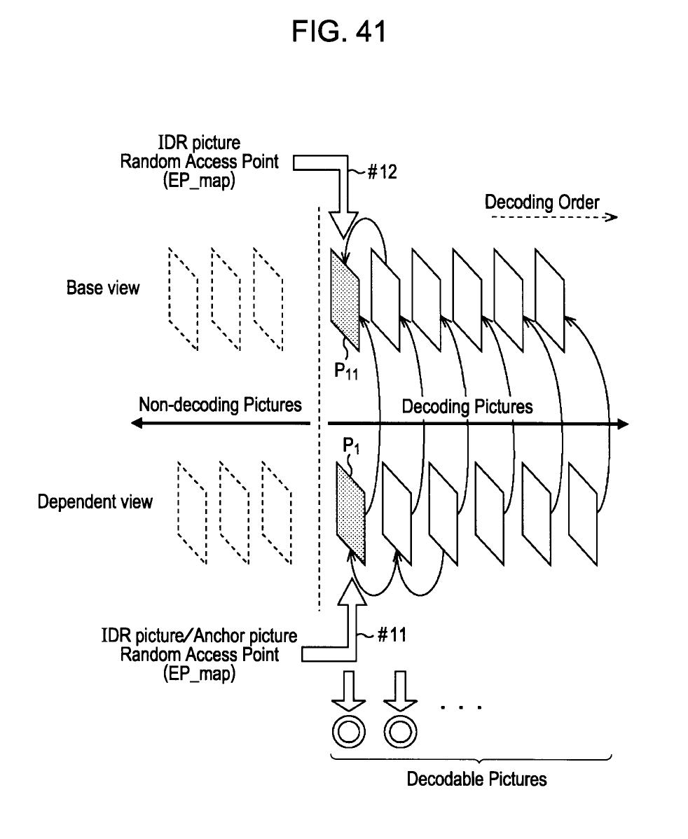

FIG. 41 is a diagram illustrating an example of a decoding starting point set in EP_map that satisfies the two restrictions above.

FIG. 41 shows that pictures forming the Base view video stream and pictures forming the Dependent view video stream in a decoding order.

A colored picture P₁ among picture of the Dependent view video stream is an anchor picture or an IDR picture. An Access Unit just before an Access Unit including the data of the picture P₁ includes the SubsetSPS.

In the example of FIG. 41, as shown by a white arrow #11, the picture P₁ is set as a decoding starting point in the EP_map of the Dependent view video stream.

A picture P₁₁ which is the picture of the Base view video stream corresponding to the picture P₁ is an IDR picture. As shown by a white arrow #12, the picture P₁₁ as an IDR picture is set as a decoding starting point in the EP_map of the Base view video stream.

Since random access or trick play is instructed, when decoding is started from the picture P₁ and the picture P₁₁, the picture P₁₁ is decoded first. Since the picture P₁₁ is an IDR picture, it is possible to decode the picture P₁₁ without referring to other pictures.

When the decoding of the picture P₁₁ is finished, the picture P₁ is decoded next. When the picture P₁ is decoded, the decoded picture P₁₁ is referred to. Since the picture P₁ is an anchor picture or an IDR picture, it is possible to decode the picture P₁ if the picture P₁₁ has been decoded.

Thereafter, decoding is performed for the next picture of the picture P₁ of the Base view video, the next picture of the picture P₁₁ of the Dependent view video, . . . , and the like.

Since the structure of the corresponding GOPs are the same, and decoding is started from the corresponding point, it is possible to decode pictures next to the pictures set in the EP_map for the Base view video and the Dependent view video without failure. Accordingly, it is possible to realize random access.

Pictures arranged in the left side of the dotted line shown in the vertical direction of FIG. 41 are pictures that are not decoded.

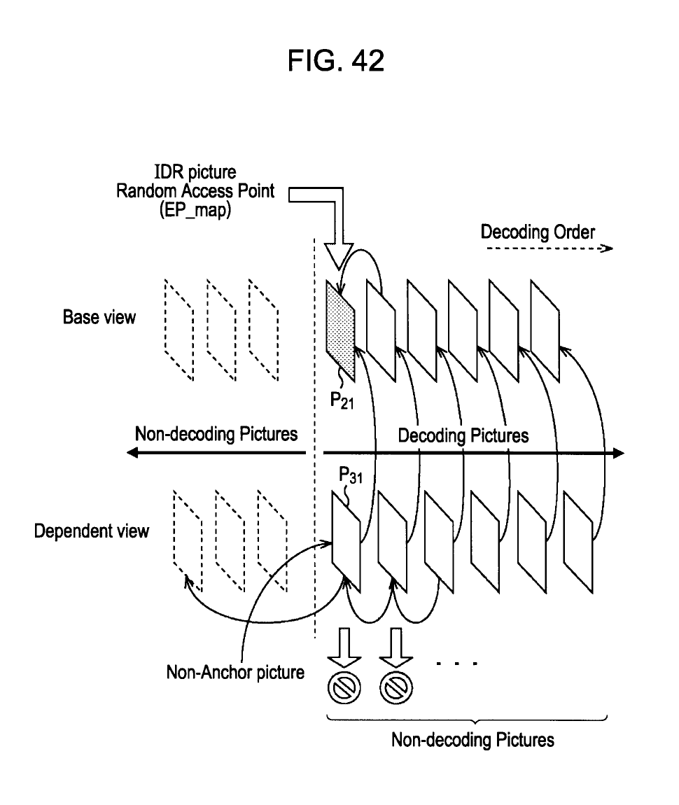

FIG. 42 is a diagram illustrating a problem occurring when the structure of a GOP of Dependent view video is not defined.

In the example of FIG. 42, a colored picture P₂₁ that is an IDR picture of the Base view video is set as a decoding starting point in the EP_map.

It is assumed that when decoding is started from a picture P₂₁ of the Base view video, a picture P₃₁ that is a picture of the Dependent view video corresponding to the picture P₂₁ is an anchor picture. When a GOP structure is not defined, it is not guaranteed that a picture of the Dependent view video corresponding to an IDR picture of the Base view video is an IDR picture or an anchor picture.

In this case, even when the decoding of the picture P₂₁ of the Base view video is finished, it is not possible to decode the picture P_{K}. The decoding of the picture P₃₁ is necessary to refers to the time direction, but pictures in the left side (earlier order in the decoding order) of the dotted line shown in the vertical direction have not been decoded.

Since the picture P₃₁ is not able to be decoded, and thereby other pictures of the Dependent view video referring to the picture P₃₁ are not able to be decoded.

By defining the GOP structure of the Dependent view video stream, it is possible to avoid such a problem.

By setting a decoding starting point in the EP_map not only for the Base view video but also for the Dependent view video, the playback apparatus 1 can easily specify the decoding starting point.

When only a picture of the Base view video is set as a decoding starting point in the EP_map, it is necessary for the playback apparatus 1 to specify a picture of the Dependent view video corresponding to a picture of the decoding starting point with calculation, and thereby the process becomes complicated.

Even if corresponding pictures of the Base view video and the Dependent view video have the same DTS/PTS, since even byte arrays are not able to be coincide in a TS in case where bit rates of videos are different, the process of the case becomes complicated.

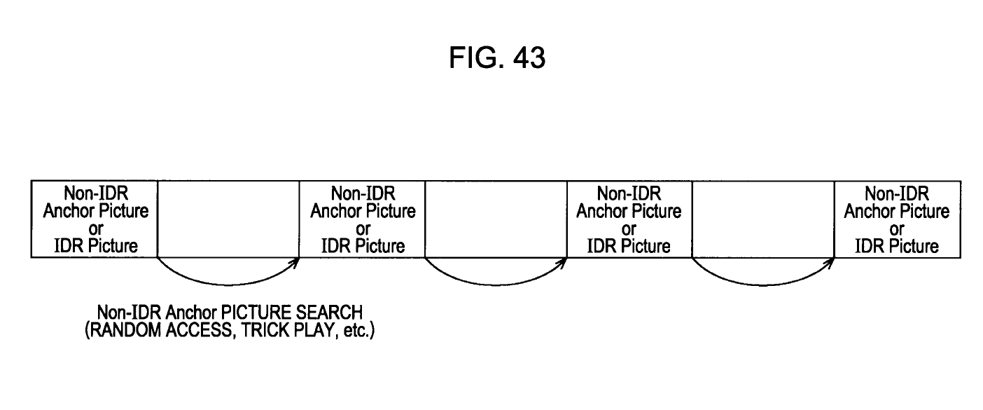

FIG. 43 is a diagram illustrating the concept of picture search when random access or trick play is performed for an MVC stream formed of the Base view video stream and the Dependent view video stream.

As shown in FIG. 43, when the random access or the trick play is performed, a non-IDR anchor picture or an IDR picture is searched, and the decoding starting point is decided.

Here, EP_map will be described. As the case where the decoding starting point of the Base view video is set in the EP_map was described, the decoding starting point of the Dependent view video is also set in the EP_map of the Dependent view video in the same manner.

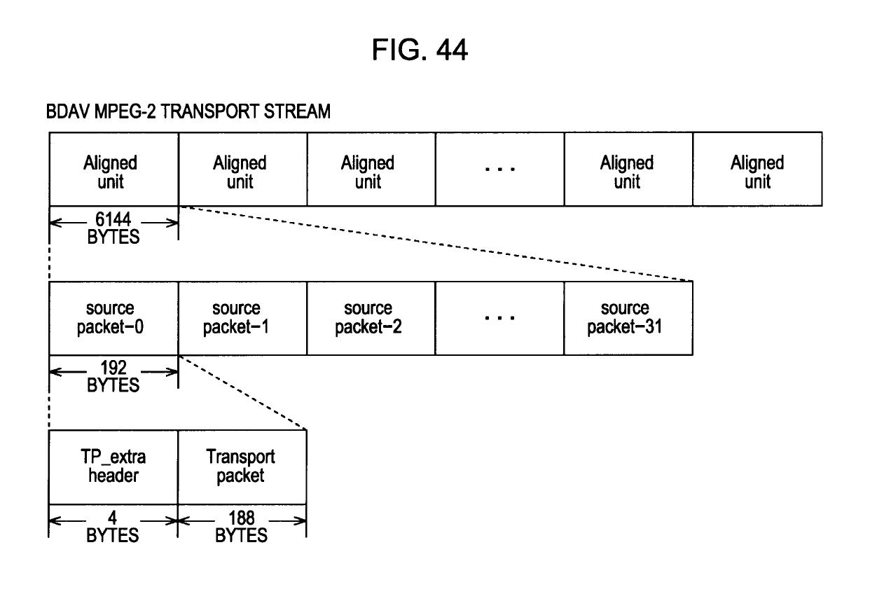

FIG. 44 is a diagram illustrating the structure of an AV stream recorded on the optical disc 2.

The TS including the Base view video stream is formed of aligned units as many as the number of integers having the size of 6144 bytes.

An aligned unit includes 32 source packets. A source packet includes 192 bytes. One source packet includes a 4-byte transport packet extra header (TP_extra header) and a 188-byte transport packet.

The data of Base view video is made to be a MPEG2 PES packet. A PES packet header is added to a data unit of a PES packet and thereby a PES packet is formed. In the PES packet header, a stream ID that specifies a type of an elementary stream transmitted by a PES packet is included.

A PES packet is further made to be a transport packet. In other words, a PES packet is divided into the size of a payload of a transport packet, a transport packet header is added to the payload and thereby a transport packet is formed. The transport packet header includes a PID which is information for identifying data accommodated in a payload.

Furthermore, a source packet number that increases one by one for each source packet is given to a source packet with the head of a Clip AV stream set to be 0. In addition, an aligned unit begins from a first byte of a source packet.

The EP_map is used for searching a data address where reading of data is to be started in Clip AV stream files when a time stamp of an access point of a Clip is given. The EP_map is a list of entry points extracted from elementary streams and transport streams.

The EP_map has address information for searching an entry point where decoding is started in an AV stream. One piece of EP data in the EP_map is formed of a pair of a PTS and an address of an Access Unit corresponding to the PTS in the AV stream. In the AVC/H.264, data as much as one picture are accommodated in one Access Unit.

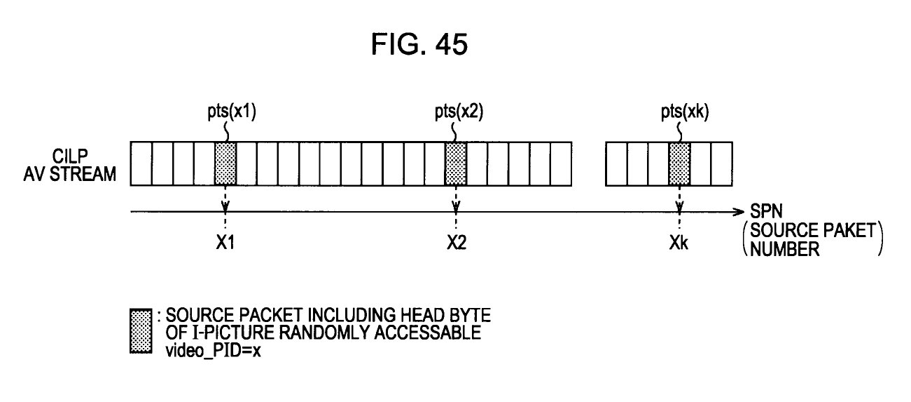

FIG. 45 is a diagram illustrating an example of a Clip AV stream.

The Clip AV stream of FIG. 45 is a video stream (Base view video stream) formed of source packets identified with PID=x. The video stream is distinguished for each source packet by a PID included in the header of the transport packet in the source packet.

In FIG. 45, source packets including head byte of IDR pictures among source pictures of the video stream are colored. Squared not colored indicates source packets including data that are not random access points or source packets including data of other streams.

For example, a source packet with a source packet number X1 including a head byte of an IDR picture of the video stream distinguished with PID=x that is randomly accessible is placed at a point of PTS=pts(x1) on a time axis of the Clip AV stream.

In the same manner, a source packet including a head byte of an IDR picture that is randomly accessible to the next is a source packet with a source packet number X2 and placed at a point of PTS=pts(x2).

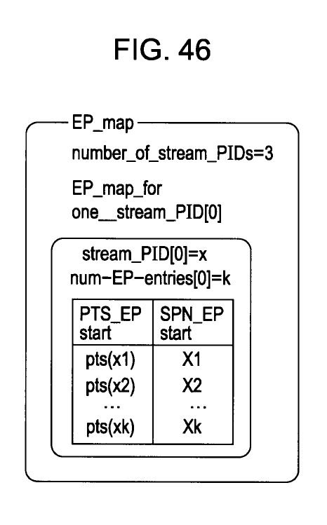

FIG. 46 is a diagram conceptually illustrating an example of an EP_map corresponding to the Clip AV stream of FIG. 45.

As shown in FIG. 46, the EP_map includes stream_PID, PTS_EP_start, and SPN_EP_start.

The stream_PID indicates a PID of a transport packet transmitting a video stream.

The PTS_EP_start indicates a PTS of an Access Unit starting from an IDR picture that is randomly accessible.

The SPN_EP_start indicates an address of a source packet including a first byte of an Access Unit referred by the value of the PTS_EP_start.

The PID of the video stream is accommodated in the stream_PID, and EP_map_for_one_stream_PID( ) which is table information indicating corresponding relation between the PTS_EP_start and the SPN_EP_start is generated.

For example, in the EP_map_for_one_stream_PID[0] of the video stream with PID=x, there is description that PTS=pts(x1) and the source packet number X1, PTS=pts(x2) and the source packet number X2, . . . , and PTS=pts(xk) and the source packet number Xk corresponding to each other.

Such a table is multiplexed in the same Clip AV stream and generated for each video stream. The EP_map including the generated table is accommodated in a Clip Information file corresponding to the Clip AV stream.

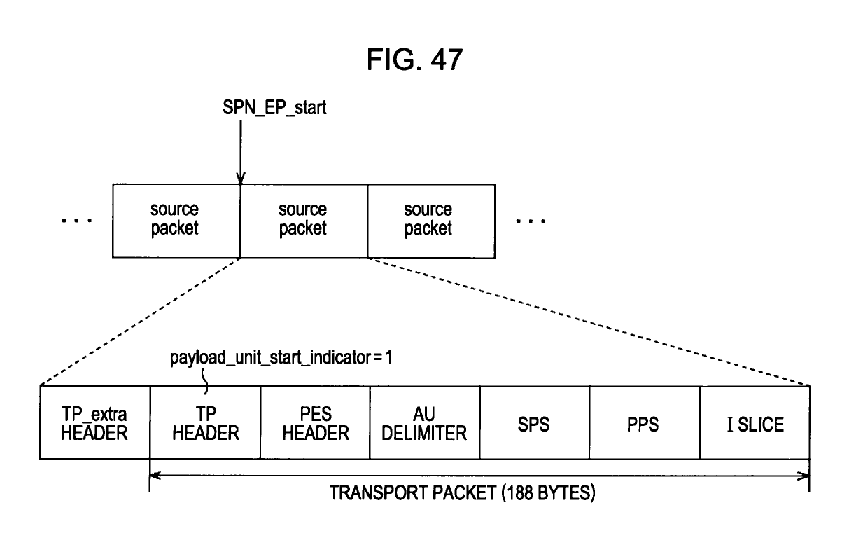

FIG. 47 is a diagram illustrating an example of the data structure of source packets that the SPN_EP_start indicates.

As described above, the source packets are formed in a way that a 188-byte transport packet is added with a 4-byte header. The portion of the transport packet is formed of a header part (TP header) and a payload part. The SPN_EP_start indicates a source packet number of a source packet including a first byte of an Access Unit starting from an IDR picture.

In the AVC/H.264, an Access Unit, that is, a picture starts from an Access Unit Delimiter (AU Delimiter). Next to the AU Delimiter, an SRS and a PPS continues. Next to that, head part or whole of data of slice of an IDR picture is accommodated.

The fact that the value of the payload_unit_start_indicator in the TP header of the transport packet is 1 indicates that a new PES packet starts from the payload of the transport packet. An Access Unit starts from the source packet.

Such EP_map is prepared for each of the Base view video stream and the Dependent view video stream.

### Operation 3

Each picture forming the Base view video stream and the Dependent view video stream is set with a picture order count (POC) during encoding. The POC is a value indicating a display order of picture.

In the AVC/H.264, the POC is defined that “A variable having a value that is non-decreasing with increasing picture position in output order relative to the previous IDR picture in decoding order or relative to the previous picture containing the memory management control operation that marks all reference pictures as “unused for reference”.

During encoding, a POC set for a picture of the Base view video stream and a POC set for a picture of the Dependent view video stream are operated uniformly.

For example, a first picture in the display order of the Base view video stream is set with POC=1, and thereafter, a POC is set to each picture by increasing the value by one.

In addition, a first picture in the display order of the Dependent view video stream is wet with the same POC=1 as that set to the first picture of the Base view video stream, and thereafter, a POC is set to each picture by increasing the value by one.

Since the GOP structure of the Base view video stream and the GOP structure of the Dependent view video stream are the same as described above, for each picture of the Base view video stream and the Dependent view video stream, the same POC is set to corresponding pictures in the display order.

Accordingly, the playback apparatus 1 can process the view components set with the same POC as a corresponding view component in the display order.

For example, the playback apparatus 1 can process the picture set with POC=1 among pictures of the Base view video stream and the picture wet with POC=1 among pictures of the Dependent view video stream as corresponding pictures.

In addition, in each picture forming the Base view video stream and the Dependent view video stream, Picture Timing supplemental enhancement information (SEI) is set. The SEI is additional information including auxiliary information regarding decoding, which is defined with the H.264/AVC.

The Picture Timing SEI, which is one of the SEI, includes time information such as a time to read from a coded picture buffer (CPB) during encoding, a time to read from DPB (DPB 151 of FIG. 22) during decoding or the like. In addition, the Picture Timing SEI includes information on a display time, a picture structure and the like.

During encoding, the Picture Timing SEI set to a picture of the Base view video stream and the Picture Timing SEI set to a picture of the Dependent view video stream are operated uniformly.

For example, when T1 is set to a first picture of the Base view video stream in the encoding order as a time to read from a CPB, T1 is also set to a first picture the Dependent view video stream in the encoding order as a time to read from the CPB.

In other words, for each picture of the Base view video stream and the Dependent view video stream, corresponding pictures in the encoding order or the decoding order are set with the Picture Timing SEI with the same contents.

Accordingly, the playback apparatus 1 can process a view components set with the same Picture Timing SEI as a corresponding view component in the decoding order.

The POC and the Picture Timing SEI are included in the elementary stream of the Base view video and the Dependent view video, and referred to by the video decoder 110 in the playback apparatus 1.

The video decoder 110 can identify a corresponding view component based on information included in the elementary stream. In addition, the video decoder 110 can perform a decoding process so as to be in a correct decoding order based on the Picture Timing SEI and correct display order based on the POC.

Since it is not necessary to refer to a PlayList or the like in order to identify a corresponding view component, it is possible to take a measure when a problem occurs in a system layer, or a layer more than that. In addition, it is possible to mount a decoder that does not depend on a layer having a problem.

A series of the process described above can be executed by hardware, and by software. When a series of the process is executed by software, a program forming the software is installed in a computer incorporated in dedicated hardware, or a general personal computer from a program recording medium.

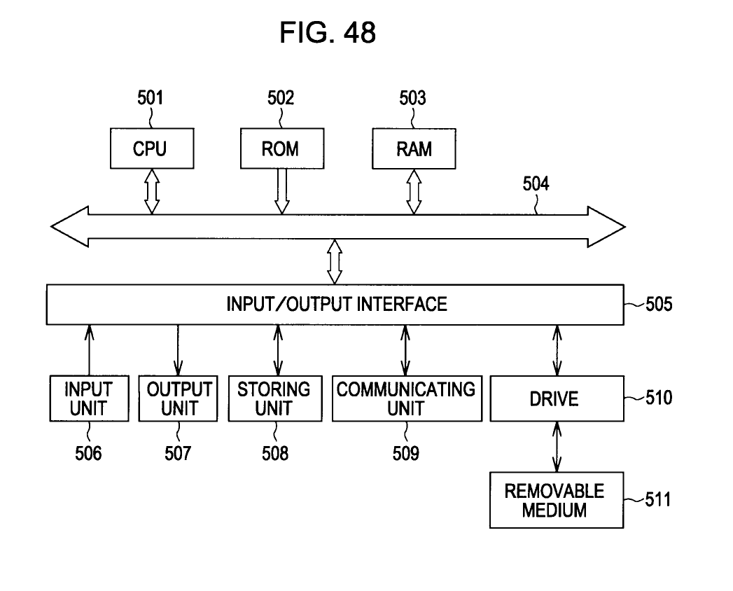

FIG. 48 is a block diagram illustrating an example of the composition of software in a computer that executes a series of the process above through a program.

A central processing unit (CPU) 501 a read only memory (ROM) 502, and a random access memory (RAM) 503 are connected to each other via a bus 504.

An input/output interface 505 is further connected to the bus 504. To the input/output interface 505, an input unit 506 including a keyboard, a mouse or the like and an output unit 507 including a display, a speaker, or the like are connected. In addition, to the bus 504, a storing unit 508 including a hard disk, nonvolatile memory, or the like, a communicating unit 509 including a network interface or the like, and a drive 510 for driving a removable medium 511 are connected.

In a computer configured as above, the CPU 501 performs a series of the process described above by, for example, loading a program stored in the storing unit 508 in the RAM 503 via the input/output interface 505 and the bus 504.

The program executed by the CPU 501 is provided, for example, by being recorded in the removable medium 511, or via a wired or a wireless transmission medium such as a local area network, the Internet, and digital broadcasting, and installed in the storing unit 508.

Furthermore, the program executed by the computer may be a program that performs a process in a time series according to the order that the present specification describes, and/or may be a program in which a process is performed at a necessary time point when the program is called out.

The present application contains subject matter related to that disclosed in Japanese Priority Patent Application JP 2009-094259 filed in the Japan Patent Office on Apr. 8, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A playback apparatus comprising:
a first decoding unit configured to decode the stream of a Base view video and the stream of a Dependent view video obtained by encoding a plurality of pieces of video data with predetermined video format;
a second decoding unit configured to decode the graphic stream of a Base view and the graphic stream of a Dependent view; and
a synthesizing unit configured to generate a first synthesizing plane by synthesizing a plane of the Base view video obtained based on the decoding result of the stream of the Base view video and a plane of Base view graphics obtained based on the decoding result of the graphic stream of the Base view, and to generate a second synthesizing plane by synthesizing a plane of the Dependent view video obtained based on the decoding result of the stream of the Dependent view video and a plane of Dependent view graphics obtained based on the decoding result of the graphic stream of the Dependent view.

2. The playback apparatus according to claim 1, further comprising:
a switching unit configured to output one synthesizing plane among the first synthesizing plane and the second synthesizing plane as a plane of a left image and to output the other synthesizing plane as a plane of a right image based on a flag indicating whether one of stream between the stream of the Base view video and the stream of the Dependent view video is a stream of the left image or a stream of the right image.

3. The playback apparatus according to claim 2, wherein the switching unit identifies whether the first synthesizing plane is a plane obtained by synthesizing planes of the Base view and whether the second synthesizing plane is a plane obtained by synthesizing planes of the Dependent view, based on a PID.

4. The playback apparatus according to claim 2, wherein the switching unit identifies whether the first synthesizing plane is a plane obtained by synthesizing planes of the Base view and whether the second synthesizing plane is a plane obtained by synthesizing planes of the Dependent view, based on a view ID set to the stream of the Dependent view video during encoding.

5. A playback method comprising the steps of:
decoding the stream of a Base view video and the stream of a Dependent view video obtained by encoding a plurality of pieces of video data with predetermined video format;
decoding the graphic stream of a Base view and the graphic stream of a Dependent view; and
generating a first synthesizing plane by synthesizing a plane of the Base view video obtained based on the decoding result of the stream of the Base view video and a plane of Base view graphics obtained based on the decoding result of the graphic stream of the Base view, and generating a second synthesizing plane by synthesizing a plane of the Dependent view video obtained based on the decoding result of the stream of the Dependent view video and a plane of Dependent view graphics obtained based on the decoding result of the graphic stream of the Dependent view.

6. A program prompting a computer to execute a process comprising the steps of:
decoding the stream of a Base view video and the stream of a Dependent view video obtained by encoding a plurality of pieces of video data with predetermined video format;
decoding the graphic stream of a Base view and the graphic stream of a Dependent view; and
generating a first synthesizing plane by synthesizing a plane of the Base view video obtained based on the decoding result of the stream of the Base view video and a plane of Base view graphics obtained based on the decoding result of the graphic stream of the Base view, and generating a second synthesizing plane by synthesizing a plane of the Dependent view video obtained based on the decoding result of the stream of the Dependent view video and a plane of Dependent view graphics obtained based on the decoding result of the graphic stream of the Dependent view.

7. A playback apparatus, comprising:
a first decoding unit configured to decode the stream of a Base view video and the stream of a Dependent view video obtained by encoding a plurality of pieces of video data with predetermined video format;
a first switching unit configured to output one plane out of a plane of the Base view video obtained based on the decoding result of the stream of the Base view video and a plane of the Dependent view video obtained based on the decoding result of the stream of the Dependent view video as a plane of a first left image and to output the other plane as a first right image based on a flag indicating whether one of stream between the stream of the Base view video and the stream of the Dependent view video is a stream of the left image or a stream of the right image;
a second decoding unit configured to decode the graphic stream of a Base view and the graphic stream of a Dependent view;
a second switching unit configured to output one plane out of a plane of Base view graphics obtained based on the decoding result of the graphic stream of the Base view and a plane of Dependent view graphics obtained based on the decoding result of the graphic stream of the Dependent view as a plane of a second left image and to output the other plane as a plane of a second right image based on the flag; and
a synthesizing unit configured to generate a first synthesizing plane by synthesizing the plane of the first left image and the plane of the second left image, and to generate a second synthesizing plane by synthesizing the plane of the first right image and the plane of the second right image.

8. A playback method comprising the steps of:
decoding the stream of a Base view video and the stream of a Dependent view video obtained by encoding a plurality of pieces of video data with predetermined video format;
outputting one plane out of a plane of the Base view video obtained based on the decoding result of the stream of the Base view video and a plane of the Dependent view video obtained based on the decoding result of the stream of the Dependent view video as a plane of a first left image and outputting the other plane as a first right image based on a flag indicating whether one of stream between the stream of the Base view video and the stream of the Dependent view video is a stream of the left image or a stream of the right image;
decoding the graphic stream of a Base view and the graphic stream of a Dependent view;
outputting one plane out of a plane of Base view graphics obtained based on the decoding result of the graphic stream of the Base view and a plane of Dependent view graphics obtained based on the decoding result of the graphic stream of the Dependent view as a plane of a second left image and outputting the other plane as a plane of a second right image based on the flag; and
generating a first synthesizing plane by synthesizing the plane of the first left image and the plane of the second left image, and generating a second synthesizing plane by synthesizing the plane of the first right image and the plane of the second right image.

9. A program prompting a computer to execute a process comprising the steps of:
decoding the stream of a Base view video and the stream of a Dependent view video obtained by encoding a plurality of pieces of video data with predetermined video format;
outputting one plane out of a plane of the Base view video obtained based on the decoding result of the stream of the Base view video and a plane of the Dependent view video obtained based on the decoding result of the stream of the Dependent view video as a plane of a first left image and outputting the other plane as a first right image based on a flag indicating whether one of stream between the stream of the Base view video and the stream of the Dependent view video is a stream of the left image or a stream of the right image;
decoding the graphic stream of a Base view and the graphic stream of a Dependent view;
outputting one plane out of a plane of Base view graphics obtained based on the decoding result of the graphic stream of the Base view and a plane of Dependent view graphics obtained based on the decoding result of the graphic stream of the Dependent view as a plane of a second left image and outputting the other plane as a plane of a second right image based on the flag;
generating a first synthesizing plane by synthesizing the plane of the first left image and the plane of the second left image; and
generating a second synthesizing plane by synthesizing the plane of the first right image and the plane of the second right image.
